(19) United States
(12) Patent Application Publication
(10) Pub. No.: US 2026/0237098 A1
(43) Pub. Date: Aug. 13, 2026

(54) OMNIDIRECTIONAL STRUCTURED LIGHT SYSTEM USING FISHEYE CAMERA AND CATADIOPTRIC PROJECTOR

(71) Applicant: UIF (University Industry Foundation), Yonsei University, Seoul (KR)

(72) Inventors: Jae Sang HYUN, Seoul (KR); Ji Hoon KIM, Seoul (KR)

(73) Assignee: UIF (University Industry Foundation), Yonsei University, Seoul (KR)

(21) Appl. No.: 19/532,073

(22) Filed: Feb. 6, 2026

(30) Foreign Application Priority Data
Feb. 12, 2025 (KR) 10-2025-0018024
Jan. 15, 2026 (KR) 10-2026-0008224

(51) Int. Cl. G06T 7/80; H04N 17/00; H04N 23/56

(52) U.S. Cl. CPC G06T 7/80; H04N 17/002; H04N 23/56

(57) ABSTRACT

An omnidirectional structured light system using a fisheye camera and a light source is disclosed. The structured light system may include an illumination unit including a light source configured to project a predetermined light pattern onto a target object through reflection or refraction; an imaging unit configured to capture the light pattern projected onto the target object using the fisheye camera; and a computing unit configured to compute and derive three-dimensional spatial information of the target object based on information on the light pattern projected by the illumination unit and information on an image captured by the imaging unit.

### CROSS-REFERENCE TO RELATED APPLICATION

This application claims priority from Korean Patent Application No. 10-2025-0018024, filed on Feb. 12, 2025, in the Korean Intellectual Property Office, and all the benefits accruing therefrom under 35 U.S.C. § 119. The contents of the above application are incorporated herein in their entirety by reference.

### BACKGROUND

### Field

The present invention relates to an omnidirectional structured light system using a fisheye camera and a reflective or refractive projector.

### Description of Related Art

The ability to comprehensively acquire three-dimensional information has become increasingly important in various fields such as robotics, indoor mapping, quality control, and virtual reality. As these fields continue to advance, the demand for precise, efficient, and robust three-dimensional sensing technologies has also grown significantly. Among various approaches, structured light systems have emerged as an important solution due to their capability to acquire dense three-dimensional data with high accuracy.

Structured light systems are well known for their high accuracy and have been successfully applied in a wide range of applications. For example, they are used in six-degree-of-freedom (6D) pose estimation for robotic manipulation, high-quality three-dimensional scanning in medical fields such as plastic surgery and dental imaging, and reverse engineering. However, conventional structured light systems typically have a limited field of view, which restricts their applicability in situations requiring omnidirectional coverage.

To address these limitations, various studies have explored omnidirectional structured light systems. For example, one approach proposes using a pyramid-shaped mirror to achieve an omnidirectional field of view. However, this approach faces challenges such as mirror alignment issues and the occurrence of blind zones between adjacent mirror reflection regions, which can degrade system performance.

Another approach employs a catadioptric camera equipped with multiple projectors to extend the field of view. While this method can help expand coverage, it tends to increase system cost and complexity. Another method utilizes a reference cylinder for calibration in an effort to improve system accuracy and reliability; however, practical difficulties may arise in precisely aligning the cylinder with the overall system.

Configurations combining a catadioptric camera and a projector have also been investigated. For example, one study applied such a configuration to robot navigation, enabling three-dimensional reconstruction from a single capture. However, this method requires an additional structured light system for calibration, which reduces its practicality.

Another approach uses a calibration procedure based on an existing omnidirectional camera model. One system adopted a particular omnidirectional camera model, but suffered from severe reprojection errors due to distortion caused by a catadioptric projector. In contrast, another study achieved lower reprojection errors by applying a different catadioptric camera model; however, this method requires additional equipment, such as a transparent acrylic checkerboard, for pre-calibration.

Moreover, the workflows of these methods can become more complex because different patterns must be used for calibration and three-dimensional reconstruction. In addition, experimental demonstrations involving dense three-dimensional reconstruction have been limited, and therefore the full potential of these approaches has not yet been thoroughly explored.

### SUMMARY

The present invention proposes an efficient omnidirectional structured light system by integrating a fisheye camera and a catadioptric projector. The proposed system is intended to overcome major limitations of conventional approaches, including alignment issues, dependence on multiple projectors, and difficulties in achieving dense three-dimensional reconstruction.

According to one aspect, the invention enables omnidirectional three-dimensional reconstruction by introducing a structured light system that combines a fisheye camera with a catadioptric projector, thereby allowing acquisition of three-dimensional data covering a full 360-degree horizontal range and a wide vertical range.

According to another aspect, the invention provides an advanced omnidirectional camera model by extending an existing omnidirectional camera model, such that robust calibration convergence can be achieved even under severe distortion caused by the catadioptric projector.

According to yet another aspect, the invention presents an optimized calibration procedure that is simplified and capable of reducing reprojection errors of both the camera and the projector without requiring additional auxiliary devices.

The problem addressed by the present invention is to efficiently acquire high-precision three-dimensional data using structured light in various environments. Through this approach, calibration errors and data distortion issues that may occur in conventional methods can be minimized, and precise measurement of objects having complex shapes or diverse materials can be achieved. In addition, by combining a fisheye camera with a catadioptric projector, the invention provides a wide field of view while offering the potential to reduce the physical size of the system.

In one aspect, the present invention provides a fisheye camera-catadioptric projector structured light system comprising a light projection unit including a light source configured to project a predetermined light pattern onto an object through reflection or refraction, an imaging unit configured to capture the light pattern projected onto the object using a fisheye camera, and a processing unit configured to compute and derive three-dimensional spatial information of the object based on information related to the light pattern projected by the light projection unit and information related to an image captured by the imaging unit.

In one embodiment, the light source may include a projector.

In one embodiment, the processing unit may include a memory storing at least one instruction and a processor, and the at least one instruction, when executed by the processor, may cause the processor to perform steps of establishing a geometric model of light rays of the structured light system, performing calibration based on the geometric model and a checkerboard having a predetermined pattern, and deriving three-dimensional spatial information of the object based on the calibrated result.

In one embodiment, the step (a) may include: (a-1) modeling ideal image-plane coordinates (u, v) and three-dimensional spatial coordinates (x, y, z) of an object using Equation (1) and Equation (2); (a-2) modeling a reflected light ray lᵣ parallel to a z-axis of a mirror using the ideal image-plane coordinates (u, v) a depth s of the reflected light ray expressed by Equation (6), and Equation (3); (a-3) modeling a light ray lᵣ′ on a real distorted image plane using the reflected light ray lᵣ, a rotation matrix R expressed by Equation (4-1), a translation vector T expressed by Equation (4-2), and Equation (4); (a-4) modeling real distorted image-plane coordinates (u′, v′) using the light ray lᵣ′ on the real distorted image plane, Equation (5), and Equation (6); (a-5) modeling a transformation relationship between the ideal image-plane coordinates (u, v) and the real distorted image-plane coordinates (u′, v′) based on Equation (7) and Equation (8); and (a-6) modeling a transformation relationship according to Equation (9) by extending an affine transform to a perspective transform through introduction of additional parameters p₃₁ and p₃₂ that reflect distortion caused by a perspective effect in Equation (7) and Equation (8), wherein

$$ρ = {( {u}^{2} + {v}^{2} )}^{\frac{1}{2}} .$$

$$X = [ \begin{matrix}x \\ y \\ Z\end{matrix} ] = λ [ \begin{matrix}u \\ v \\ f ( u , v )\end{matrix} ] \qquad Equation ( 1 )$$

$$f ( u , v ) = {a}_{0} + {a}_{2} {ρ}^{2} + {a}_{3} {ρ}^{3} + {a}_{4} {ρ}^{4} + {a}_{5} {ρ}^{5} \qquad Equation ( 2 )$$

$${l}_{r} = [ \begin{matrix}u \\ v \\ s\end{matrix} ] \qquad Equation ( 3 )$$

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] \qquad Equation ( 4 )$$

$$[ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad Equation ( 4 - 1 )$$

$$[ \begin{matrix}{t}_{1} \\ {t}_{2} \\ {t}_{3}\end{matrix} ] \qquad Equation ( 4 - 2 )$$

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] = [ \begin{matrix}{u}^{′} \\ {v}^{′} \\ 0\end{matrix} ] \qquad Equation ( 5 )$$

$$s = - \frac{{r}_{31} u + {r}_{32} v + {t}_{3}}{{r}_{33}} \qquad Equation ( 6 )$$

$$[ \begin{matrix}{u}^{′} \\ {v}^{′}\end{matrix} ] = [ \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] \qquad Equation ( 7 )$$

$$[ \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] = [ \begin{matrix}{a}_{11} & {a}_{12} \\ {a}_{21} & {a}_{22}\end{matrix} ] [ \begin{matrix}u \\ v\end{matrix} ] + [ \begin{matrix}{c}_{1} \\ {c}_{2}\end{matrix} ] \qquad Equation ( 8 )$$

$${λ}_{projection} [ \begin{matrix}{u}^{′} \\ {v}^{′} \\ 1\end{matrix} ] = [ \begin{matrix}{p}_{11} & {p}_{12} & {p}_{13} \\ {p}_{21} & {p}_{22} & {p}_{23} \\ {p}_{31} & {p}_{32} & 1\end{matrix} ] [ \begin{matrix}u \\ v \\ 1\end{matrix} ] \qquad Equation ( 9 )$$

In one embodiment, the step (b) may include: (b-1) extending an existing omnidirectional camera model using the ideal image-plane coordinates (u, v), the real distorted image-plane coordinates (u′, v′), the parameters p₃₁ and p₃₂, and Equation (10); (b-2) deriving a relationship between ideal image-plane coordinates of a specific point on the object and a three-dimensional position of the point using Equation (11), Equation (12), a rotation matrix R and a translation vector T; (b-3) deriving relational equations expressed by Equation (13a), Equation (13b), and Equation (13c) from Equation (12); (b-4) deriving a relationship expressed by Equation (14) between a calibration parameter vector H expressed by Equation (15) and a calibration data matrix M expressed by Equation (16), and obtaining a solution using a least-squares method; (b-5) deriving coefficients aₙ of Equation (2) using transformation coefficients A, B, C, and D expressed by Equation (18) and Equation (19), which are related to elements of the rotation matrix R, three-dimensional coordinates of checkerboard corners, and elements of the translation vector T, together with Equation (17); (b-6) deriving a residual function r r representing a difference between an actual coordinate and a predicted coordinate using Equation (20), wherein m is one of the real distorted image-plane coordinates (u′, v′), i is a coordinate predicted by the model, and k indicates an axis of the coordinate; (b-7) defining an error function E based on the residual function r, the parameters p₃₁ and p₃₂, and Equation (21), and searching for parameters expressed as a set in Equation (22) to minimize the error function; and (b-8) transforming a coordinate system of the light source and a coordinate system of the fisheye camera using Equation (23), and performing nonlinear optimization on parameters to be optimized expressed by Equation (24), wherein: A is a scale factor; x and y are three-dimensional coordinates of checkerboard corners; superscript i denotes an index of each checkerboard; subscript j denotes an index of each corner of the checkerboard; L is a number of corners of the checkerboard; K is a number of checkerboards used for calibration; P is a projection matrix defined in Equation (9); in Equation (20), k is 1 when m is u′, and 2 when m is v′; an arrow in Equation (23) indicates a direction of coordinate transformation; proj denotes the light source; cam denotes a fisheye camera coordinate system; and board denotes the checkerboard.

$$[ \begin{matrix}{u}^{′} \\ {v}^{′} \\ 1\end{matrix} ] = [ \begin{matrix}1 & 0 & {p}_{13} \\ 0 & 1 & {p}_{23} \\ 0 & 0 & 1\end{matrix} ] [ \begin{matrix}u \\ v \\ 1\end{matrix} ] \qquad Equation ( 10 )$$

$$λ [ \begin{matrix}{u}_{j}^{i} \\ {v}_{j}^{i} \\ f ( {u}_{j}^{i} , {v}_{j}^{i} )\end{matrix} ] = [ \begin{matrix}{r}_{1}^{i} & {r}_{2}^{i} & {r}_{3}^{i} & {t}^{i}\end{matrix} ] [ \begin{matrix}{x}_{j}^{i} \\ {y}_{j}^{i} \\ 0 \\ 1\end{matrix} ] = [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] \qquad Equation ( 11 )$$

$$[ \begin{matrix}{u}_{j}^{i} \\ {v}_{j}^{i} \\ f ( {u}_{j}^{i} , {v}_{j}^{i} )\end{matrix} ] \times [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] = 0 \qquad Equation ( 12 )$$

$${v}_{j}^{i} \cdot ( {r}_{31}^{i} {x}_{j}^{i} + {r}_{32}^{i} {y}_{j}^{i} + {t}_{3}^{i} ) - f ( {u}_{j}^{i} , {v}_{j}^{i} ) \cdot ( {r}_{21}^{i} {x}_{j}^{i} + {r}_{22}^{i} {y}_{j}^{i} + {t}_{2}^{i} ) = 0 \qquad Equation ( 13 a )$$

$$f ( {u}_{j}^{i} , {v}_{j}^{i} ) \cdot ( {r}_{11}^{i} {x}_{j}^{i} + {r}_{12}^{i} {y}_{j}^{i} + {t}_{1}^{i} ) - {u}_{j}^{i} \cdot ( {r}_{31}^{i} {x}_{j}^{i} + {r}_{32}^{i} {y}_{j}^{i} + {t}_{3}^{i} ) = 0 \qquad Equation ( 13 b )$$

$${u}_{j}^{i} \cdot ( {r}_{21}^{i} {x}_{j}^{i} + {r}_{22}^{i} {y}_{j}^{i} + {t}_{2}^{i} ) - {v}_{j}^{i} \cdot ( {r}_{11}^{i} {x}_{j}^{i} + {r}_{12}^{i} {y}_{j}^{i} + {t}_{1}^{i} ) = 0 \qquad Equation ( 13 c )$$

$$M \cdot H = 0 \qquad Equation ( 14 )$$

$$H = {[ {r}_{11}^{i} , {r}_{12}^{i} , {r}_{21}^{i} , {r}_{22}^{i} , {t}_{1}^{i} , {t}_{2}^{i} ]}^{T} \qquad Equation ( 15 )$$

$$M = [ \begin{matrix}- {v}_{1}^{i} {x}_{1}^{i} & - {v}_{1}^{i} {y}_{1}^{i} & {u}_{1}^{i} {x}_{1}^{i} & {u}_{1}^{i} {y}_{1}^{i} & - {v}_{1}^{i} & {u}_{1}^{i} \\ ⋮ & ⋮ & ⋮ & ⋮ & ⋮ & ⋮ \\ - {v}_{L}^{i} {x}_{L}^{i} & - {v}_{L}^{i} {y}_{L}^{i} & {u}_{L}^{i} {x}_{L}^{i} & {u}_{L}^{i} {y}_{L}^{i} & - {v}_{L}^{i} & {u}_{L}^{i}\end{matrix} ] \qquad Equation ( 16 )$$

$$[ \begin{matrix}{A}_{1}^{1} & {{A}_{1}^{1} ( {ρ}_{1}^{1} )}^{2} & {A}_{1}^{1} {( {ρ}_{1}^{1} )}^{3} & {A}_{1}^{1} {( {ρ}_{1}^{1} )}^{4} & - {v}_{1}^{1} & 0 & ⋯ & 0 \\ {C}_{1}^{1} & {{C}_{1}^{1} ( {ρ}_{1}^{1} )}^{2} & {{C}_{1}^{1} ( {ρ}_{1}^{1} )}^{3} & {{C}_{1}^{1} ( {ρ}_{1}^{1} )}^{4} & - {u}_{1}^{1} & 0 & ⋯ & 0 \\ {A}_{2}^{1} & {A}_{2}^{1} {( {ρ}_{2}^{1} )}^{2} & {A}_{2}^{1} {( {ρ}_{2}^{1} )}^{3} & {A}_{2}^{1} {( {ρ}_{2}^{1} )}^{4} & - {v}_{2}^{1} & 0 & ⋯ & 0 \\ {C}_{2}^{1} & {{C}_{2}^{1} ( {ρ}_{2}^{1} )}^{2} & {{C}_{2}^{1} ( {ρ}_{2}^{1} )}^{3} & {{C}_{2}^{1} ( {ρ}_{2}^{1} )}^{4} & - {u}_{2}^{1} & 0 & ⋯ & 0 \\ ⋮ & ⋮ & ⋮ & ⋮ & ⋮ & ⋮ & ⋱ & ⋮ \\ {A}_{L}^{K} & {{A}_{L}^{K} ( {ρ}_{L}^{K} )}^{2} & {{A}_{L}^{K} ( {ρ}_{L}^{K} )}^{3} & {{A}_{L}^{K} ( {ρ}_{L}^{K} )}^{4} & 0 & 0 & ⋯ & - {v}_{L}^{K} \\ {C}_{L}^{K} & {{C}_{L}^{K} ( {ρ}_{L}^{K} )}^{2} & {C}_{L}^{K} {( {ρ}_{L}^{K} )}^{3} & {C}_{L}^{K} {( {ρ}_{L}^{K} )}^{4} & 0 & 0 & ⋯ & - {u}_{L}^{K}\end{matrix} ] [ \begin{matrix}{a}_{0} \\ {a}_{2} \\ {a}_{3} \\ {a}_{4} \\ {t}_{3}^{1} \\ {t}_{3}^{2} \\ ⋮ \\ {t}_{3}^{k}\end{matrix} ] = [ \begin{matrix}{B}_{1}^{1} \\ {D}_{1}^{1} \\ {B}_{2}^{1} \\ {D}_{2}^{1} \\ ⋮ \\ {B}_{L}^{K} \\ {D}_{L}^{K}\end{matrix} ] \qquad Equation ( 17 )$$

$${A}_{j}^{i} = {r}_{21}^{i} {x}_{j}^{i} + {r}_{22}^{i} {y}_{j}^{i} + {t}_{2}^{i} , {B}_{j}^{i} = {v}_{j}^{i} \cdot ( {r}_{31}^{i} {x}_{j}^{i} + {r}_{32}^{i} {y}_{j}^{i} ) \qquad Equation ( 18 )$$

$${C}_{j}^{i} = {r}_{11}^{i} {x}_{j}^{i} + {r}_{12}^{i} {y}_{j}^{i} + {t}_{1}^{i} , {D}_{j}^{i} = {u}_{j}^{i} \cdot ( {r}_{31}^{i} {x}_{j}^{i} + {r}_{32}^{i} {y}_{j}^{i} ) \qquad Equation ( 19 )$$

$$r ( m , \hat{m} , k ) = m - \hat{m} \qquad Equation ( 20 )$$

$${\sum }_{i = 1}^{K} {\sum }_{j = 1}^{L} {\sum }_{k = 1}^{2} {r ( m , \hat{m} ( \hat{U} , {M}_{j}^{i} ) , k )}^{2} + {( {p}_{31} )}^{2} + {( {p}_{32} )}^{2} \qquad Equation ( 21 )$$

$$\hat{U} = [ {r}^{i} , {t}^{i} , a , P ] \qquad Equation ( 22 )$$

$${T}_{proj \to cam} = \frac{1}{K} {\sum }_{i = 1}^{K} ( {{T}_{board \to cam}^{i} ( {T}_{board \to proj}^{i} )}^{- 1} ) \qquad Equation ( 23 )$$

$$\hat{U} = [ {r}_{proj \to cam} , {t}_{proj \to cam} , {a}_{p} , {P}_{p} ] \qquad Equation ( 24 )$$

In one embodiment, the step (c) may include: (c-1) deriving a light ray l_{c} originating from a virtual paraboloid center using Equation (25) based on undistorted camera pixel coordinates (u_{c}, v_{c}); (c-2) deriving, in a camera coordinate system, a light ray lₚ from pixel coordinates (uₚ, vₚ) of the light source using Equation (26); and (c-3) deriving Equation (27) or Equation (28) from the camera light ray l_{c} and the light source light ray lₚ, obtaining a scale factor λ_{c} therefrom, and deriving a reconstructed three-dimensional point X in space by substituting the scale factor λ_{c} into Equation (25), wherein Oₚ is an origin of the light source.

$${l}_{c} = {λ}_{c} [ \begin{matrix}{u}_{c} \\ {v}_{c} \\ f ( {u}_{c} , {v}_{c} )\end{matrix} ] = {λ}_{c} [ \begin{matrix}{c}_{1} \\ {c}_{2} \\ {c}_{3}\end{matrix} ] \qquad Equation ( 25 )$$

$${l}_{p} = {λ}_{p} {R}_{proj \to cam} [ \begin{matrix}{u}_{p} \\ {v}_{p} \\ f ( {u}_{p} , {v}_{p} )\end{matrix} ] + {O}_{p} = {λ}_{p} [ \begin{matrix}{p}_{1} \\ {p}_{2} \\ {p}_{3}\end{matrix} ] + {O}_{p} \qquad Equation ( 26 )$$

$$X = {λ}_{c} [ \begin{matrix}{c}_{1} \\ {c}_{2} \\ {c}_{3}\end{matrix} ] = {λ}_{p} [ \begin{matrix}{p}_{1} \\ {p}_{2} \\ {p}_{3}\end{matrix} ] + [ \begin{matrix}{O}_{{p}_{x}} \\ {O}_{{p}_{y}} \\ {O}_{{p}_{z}}\end{matrix} ] \qquad Equation ( 27 )$$

$$[ \begin{matrix}{c}_{1} & - {p}_{1} \\ {c}_{2} & - {p}_{2} \\ {c}_{3} & - {p}_{3}\end{matrix} ] [ \begin{matrix}{λ}_{c} \\ {λ}_{p}\end{matrix} ] = [ \begin{matrix}{O}_{{p}_{x}} \\ {O}_{{p}_{y}} \\ {O}_{{p}_{z}}\end{matrix} ] \qquad Equation ( 28 )$$

In another aspect, the present invention provides a spatial information acquisition method using a fisheye camera and a catadioptric projector, the method including a first step of projecting, using a light source, a predetermined light pattern onto an object through reflection or refraction, a second step of capturing, using the fisheye camera, the light pattern projected onto the object, and a third step of computing and deriving three-dimensional spatial information of the object based on information related to the light pattern and information related to an image captured by the fisheye camera.

In one embodiment, the light source may include a catadioptric projector.

In one embodiment, the third step may be performed by establishing a geometric model of light rays of the structured light system, performing calibration based on the geometric model and a checkerboard having a predetermined pattern, and deriving three-dimensional spatial information of the object based on the calibrated result.

In one embodiment, the step (a) may include: (a-1) modeling ideal image-plane coordinates (u, v) and three-dimensional spatial coordinates (x, y, z) of an object using Equation (1) and Equation (2); (a-2) modeling a reflected light ray lᵣ parallel to a z-axis of a mirror using the ideal image-plane coordinates (u, v) a depth s of the reflected light ray expressed by Equation (6), and Equation (3); (a-3) modeling a light ray lᵣ′ on a real distorted image plane using the reflected light ray lᵣ, a rotation matrix R expressed by Equation (4-1), a translation vector T expressed by Equation (4-2), and Equation (4); (a-4) modeling real distorted image-plane coordinates (u′, v′) using the light ray lᵣ′ on the real distorted image plane, Equation (5), and Equation (6); (a-5) modeling a transformation relationship between the ideal image-plane coordinates (u, v) and the real distorted image-plane coordinates (u′, v′) based on Equation (7) and Equation (8); and (a-6) modeling a transformation relationship according to Equation (9) by extending an affine transform to a perspective transform through introduction of additional parameters p₃₁ and p₃₂ that reflect distortion caused by a perspective effect in Equation (7) and Equation (8), wherein

$$ρ = {( {u}^{2} + {v}^{2} )}^{\frac{1}{2}} .$$

$$X = [ \begin{matrix}x \\ y \\ Z\end{matrix} ] = λ [ \begin{matrix}u \\ v \\ f ( u , v )\end{matrix} ] \qquad Equation ( 1 )$$

$$f ( u , v ) = {a}_{0} + {a}_{2} {ρ}^{2} + {a}_{3} {ρ}^{3} + {a}_{4} {ρ}^{4} + {a}_{5} {ρ}^{5} \qquad Equation ( 2 )$$

$${l}_{r} = [ \begin{matrix}u \\ v \\ s\end{matrix} ] \qquad Equation ( 3 )$$

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] \qquad Equation ( 4 )$$

$$[ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad Equation ( 4 - 1 )$$

$$[ \begin{matrix}{t}_{1} \\ {t}_{2} \\ {t}_{3}\end{matrix} ] \qquad Equation ( 4 - 2 )$$

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] = [ \begin{matrix}{u}^{′} \\ {v}^{′} \\ 0\end{matrix} ] \qquad Equation ( 5 )$$

$$s = - \frac{{r}_{31} u + {r}_{32} v + {t}_{3}}{{r}_{33}} \qquad Equation ( 6 )$$

$$[ \begin{matrix}{u}^{′} \\ {v}^{′}\end{matrix} ] = [ \begin{matrix}{r}_{11} - \frac{{r}_{13} {r}_{31}}{{r}_{33}} & {r}_{12} - \frac{{r}_{13} {r}_{33}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] \qquad Equation ( 7 )$$

$$[ \begin{matrix}{r}_{11} - \frac{{r}_{13} {r}_{31}}{{r}_{33}} & {r}_{12} - \frac{{r}_{13} {r}_{33}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] = [ \begin{matrix}{a}_{11} & {a}_{12} \\ {a}_{21} & {a}_{22}\end{matrix} ] [ \begin{matrix}u \\ v\end{matrix} ] + [ \begin{matrix}{c}_{1} \\ {c}_{2}\end{matrix} ] \qquad Equation ( 8 )$$

$${λ}_{projection} [ \begin{matrix}{u}^{′} \\ {v}^{′} \\ 1\end{matrix} ] = [ \begin{matrix}{p}_{11} & {p}_{12} & {p}_{13} \\ {p}_{21} & {p}_{22} & {p}_{23} \\ {p}_{31} & {p}_{32} & 1\end{matrix} ] [ \begin{matrix}u \\ v \\ 1\end{matrix} ] \qquad Equation ( 9 )$$

In one embodiment, the step (b) may include: (b-1) extending an existing omnidirectional camera model using the ideal image-plane coordinates (u, v), the real distorted image-plane coordinates (u′, v′), the parameters p₃₁ and p₃₂, and Equation (10); (b-2) deriving a relationship between ideal image-plane coordinates of a specific point on the object and a three-dimensional position of the point using Equation (11), Equation (12), a rotation matrix R and a translation vector T; (b-3) deriving relational equations expressed by Equation (13a), Equation (13b), and Equation (13c) from Equation (12); (b-4) deriving a relationship expressed by Equation (14) between a calibration parameter vector H expressed by Equation (15) and a calibration data matrix M expressed by Equation (16), and obtaining a solution using a least-squares method; (b-5) deriving coefficients aₙ of Equation (2) using transformation coefficients A, B, C, and D expressed by Equation (18) and Equation (19), which are related to elements of the rotation matrix R, three-dimensional coordinates of checkerboard corners, and elements of the translation vector T, together with Equation (17); (b-6) deriving a residual function r r representing a difference between an actual coordinate and a predicted coordinate using Equation (20), wherein m is one of the real distorted image-plane coordinates (u′, v′), \hat{m} is a coordinate predicted by the model, and k indicates an axis of the coordinate; (b-7) defining an error function E based on the residual function r, the parameters p₃₁ and p₃₂, and Equation (21), and searching for parameters expressed as a set in Equation (22) to minimize the error function; and (b-8) transforming a coordinate system of the light source and a coordinate system of the fisheye camera using Equation (23), and performing nonlinear optimization on parameters to be optimized expressed by Equation (24), wherein: λ is a scale factor; x and y are three-dimensional coordinates of checkerboard corners; superscript i denotes an index of each checkerboard; subscript j denotes an index of each corner of the checkerboard; L is a number of corners of the checkerboard; K is a number of checkerboards used for calibration; P is a projection matrix defined in Equation (9); in Equation (20), k is 1 when m is u′, and 2 when m is v′; an arrow in Equation (23) indicates a direction of coordinate transformation; proj denotes the light source; cam denotes a fisheye camera coordinate system; and board denotes the checkerboard.

$$[ \begin{matrix}{u}^{′} \\ {v}^{′} \\ 1\end{matrix} ] = [ \begin{matrix}1 & 0 & {p}_{13} \\ 0 & 1 & {p}_{23} \\ 0 & 0 & 1\end{matrix} ] [ \begin{matrix}u \\ v \\ 1\end{matrix} ] \qquad Equation ( 10 )$$

$$λ [ \begin{matrix}{u}_{j}^{i} \\ {v}_{j}^{i} \\ f ( {u}_{j}^{i} , {v}_{j}^{i} )\end{matrix} ] = [ \begin{matrix}{r}_{1}^{i} & {r}_{2}^{i} & {r}_{3}^{i} & {t}^{i}\end{matrix} ] [ \begin{matrix}{x}_{j}^{i} \\ {y}_{j}^{i} \\ 0 \\ 1\end{matrix} ] = [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] \qquad Equation ( 11 )$$

$$[ \begin{matrix}{u}_{j}^{i} \\ {v}_{j}^{i} \\ f ( {u}_{j}^{i} , {v}_{j}^{i} )\end{matrix} ] \times [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] = 0 \qquad Equation ( 12 )$$

$${v}_{j}^{i} \cdot ( {r}_{31}^{i} {x}_{j}^{i} + {r}_{32}^{i} {y}_{j}^{i} + {t}_{3}^{i} ) - f ( {u}_{j}^{i} , {v}_{j}^{i} ) \cdot ( {r}_{21}^{i} {x}_{j}^{i} + {r}_{22}^{i} {y}_{j}^{i} + {t}_{2}^{i} ) = 0 \qquad Equation ( 13 a )$$

$$f ( {u}_{j}^{i} , {v}_{j}^{i} ) \cdot ( {r}_{11}^{i} {x}_{j}^{i} + {r}_{12}^{i} {y}_{j}^{i} + {t}_{1}^{i} ) - {u}_{j}^{i} \cdot ( {r}_{31}^{i} {x}_{j}^{i} + {r}_{32}^{i} {y}_{j}^{i} + {t}_{3}^{i} ) = 0 \qquad Equation ( 13 b )$$

$${u}_{j}^{i} \cdot ( {r}_{21}^{i} {x}_{j}^{i} + {r}_{22}^{i} {y}_{j}^{i} + {t}_{2}^{i} ) - {v}_{j}^{i} \cdot ( {r}_{11}^{i} {x}_{j}^{i} + {r}_{12}^{i} {y}_{j}^{i} + {t}_{1}^{i} ) = 0 \qquad Equation ( 13 c )$$

$$M \cdot H = 0 \qquad Equation ( 14 )$$

$$H = {[ {r}_{11}^{i} , {r}_{12}^{i} , {r}_{21}^{i} , {r}_{22}^{i} , {t}_{1}^{i} , {t}_{2}^{i} ]}^{T} \qquad Equation ( 15 )$$

$$M = [ \begin{matrix}- {v}_{1}^{i} {x}_{1}^{i} & - {v}_{1}^{i} {y}_{1}^{i} & {u}_{1}^{i} {x}_{1}^{i} & {u}_{1}^{i} {y}_{1}^{i} & - {v}_{1}^{i} & {u}_{1}^{i} \\ ⋮ & ⋮ & ⋮ & ⋮ & ⋮ & ⋮ \\ - {v}_{L}^{i} {x}_{L}^{i} & - {v}_{L}^{i} {y}_{L}^{i} & {u}_{L}^{i} {x}_{L}^{i} & {u}_{L}^{i} {y}_{L}^{i} & - {v}_{L}^{i} & {u}_{L}^{i}\end{matrix} ] \qquad Equation ( 16 )$$

$$[ \begin{matrix}{A}_{1}^{1} & {{A}_{1}^{1} ( {ρ}_{1}^{1} )}^{2} & {A}_{1}^{1} {( {ρ}_{1}^{1} )}^{3} & {A}_{1}^{1} {( {ρ}_{1}^{1} )}^{4} & - {v}_{1}^{1} & 0 & ⋯ & 0 \\ {C}_{1}^{1} & {{C}_{1}^{1} ( {ρ}_{1}^{1} )}^{2} & {{C}_{1}^{1} ( {ρ}_{1}^{1} )}^{3} & {{C}_{1}^{1} ( {ρ}_{1}^{1} )}^{4} & - {u}_{1}^{1} & 0 & ⋯ & 0 \\ {A}_{2}^{1} & {A}_{2}^{1} {( {ρ}_{2}^{1} )}^{2} & {A}_{2}^{1} {( {ρ}_{2}^{1} )}^{3} & {A}_{2}^{1} {( {ρ}_{2}^{1} )}^{4} & - {v}_{2}^{1} & 0 & ⋯ & 0 \\ {C}_{2}^{1} & {{C}_{2}^{1} ( {ρ}_{2}^{1} )}^{2} & {{C}_{2}^{1} ( {ρ}_{2}^{1} )}^{3} & {{C}_{2}^{1} ( {ρ}_{2}^{1} )}^{4} & - {u}_{2}^{1} & 0 & ⋯ & 0 \\ ⋮ & ⋮ & ⋮ & ⋮ & ⋮ & ⋮ & ⋱ & ⋮ \\ {A}_{L}^{K} & {{A}_{L}^{K} ( {ρ}_{L}^{K} )}^{2} & {{A}_{L}^{K} ( {ρ}_{L}^{K} )}^{3} & {{A}_{L}^{K} ( {ρ}_{L}^{K} )}^{4} & 0 & 0 & ⋯ & - {v}_{L}^{K} \\ {C}_{L}^{K} & {{C}_{L}^{K} ( {ρ}_{L}^{K} )}^{2} & {C}_{L}^{K} {( {ρ}_{L}^{K} )}^{3} & {C}_{L}^{K} {( {ρ}_{L}^{K} )}^{4} & 0 & 0 & ⋯ & - {u}_{L}^{K}\end{matrix} ] [ \begin{matrix}{a}_{0} \\ {a}_{2} \\ {a}_{3} \\ {a}_{4} \\ {t}_{3}^{1} \\ {t}_{3}^{2} \\ ⋮ \\ {t}_{3}^{k}\end{matrix} ] = [ \begin{matrix}{B}_{1}^{1} \\ {D}_{1}^{1} \\ {B}_{2}^{1} \\ {D}_{2}^{1} \\ ⋮ \\ {B}_{L}^{K} \\ {D}_{L}^{K}\end{matrix} ] \qquad Equation ( 17 )$$

$${A}_{j}^{i} = {r}_{21}^{i} {x}_{j}^{i} + {r}_{22}^{i} {y}_{j}^{i} + {t}_{2}^{i} , {B}_{j}^{i} = {v}_{j}^{i} \cdot ( {r}_{31}^{i} {x}_{j}^{i} + {r}_{32}^{i} {y}_{j}^{i} ) \qquad Equation ( 18 )$$

$${C}_{j}^{i} = {r}_{11}^{i} {x}_{j}^{i} + {r}_{12}^{i} {y}_{j}^{i} + {t}_{1}^{i} , {D}_{j}^{i} = {u}_{j}^{i} \cdot ( {r}_{31}^{i} {x}_{j}^{i} + {r}_{32}^{i} {y}_{j}^{i} ) \qquad Equation ( 19 )$$

$$r ( m , \hat{m} , k ) = m - \hat{m} \qquad Equation ( 20 )$$

$${\sum }_{i = 1}^{K} {\sum }_{j = 1}^{L} {\sum }_{k = 1}^{2} {r ( m , \hat{m} ( \hat{U} , {M}_{j}^{i} ) , k )}^{2} + {( {p}_{31} )}^{2} + {( {p}_{32} )}^{2} \qquad Equation ( 21 )$$

$$\hat{U} = [ {r}^{i} , {t}^{i} , a , P ] \qquad Equation ( 22 )$$

$${T}_{proj \to cam} = \frac{1}{K} {\sum }_{i = 1}^{K} ( {{T}_{board \to cam}^{i} ( {T}_{board \to proj}^{i} )}^{- 1} ) \qquad Equation ( 23 )$$

$$\hat{U} = [ {r}_{proj \to cam} , {t}_{proj \to cam} , {a}_{p} , {P}_{p} ] \qquad Equation ( 24 )$$

In one embodiment, the step (c) may include: (c-1) deriving a light ray l_{c} originating from a virtual paraboloid center using Equation (25) based on undistorted camera pixel coordinates (u_{c}, v_{c}); (c-2) deriving, in a camera coordinate system, a light ray lₚ from pixel coordinates (uₚ, vₚ) of the light source using Equation (26); and (c-3) deriving Equation (27) or Equation (28) from the camera light ray l_{c} and the light source light ray lₚ, obtaining a scale factor λ_{c} therefrom, and deriving a reconstructed three-dimensional point X in space by substituting the scale factor λ_{c} into Equation (25), wherein Oₚ is an origin of the light source.

$${l}_{c} = {λ}_{c} [ \begin{matrix}{u}_{c} \\ {v}_{c} \\ f ( {u}_{c} , {v}_{c} )\end{matrix} ] = {λ}_{c} [ \begin{matrix}{c}_{1} \\ {c}_{2} \\ {c}_{3}\end{matrix} ] \qquad Equation ( 25 )$$

$${l}_{p} = {λ}_{p} {R}_{proj \to cam} [ \begin{matrix}{u}_{p} \\ {v}_{p} \\ f ( {u}_{p} , {v}_{p} )\end{matrix} ] + {O}_{p} = {λ}_{p} [ \begin{matrix}{p}_{1} \\ {p}_{2} \\ {p}_{3}\end{matrix} ] + {O}_{p} \qquad Equation ( 26 )$$

$$X = {λ}_{c} [ \begin{matrix}{c}_{1} \\ {c}_{2} \\ {c}_{3}\end{matrix} ] = {λ}_{p} [ \begin{matrix}{p}_{1} \\ {p}_{2} \\ {p}_{3}\end{matrix} ] + [ \begin{matrix}{O}_{{p}_{x}} \\ {O}_{{p}_{y}} \\ {O}_{{p}_{z}}\end{matrix} ] \qquad Equation ( 27 )$$

$$[ \begin{matrix}{c}_{1} & - {p}_{1} \\ {c}_{2} & - {p}_{2} \\ {c}_{3} & - {p}_{3}\end{matrix} ] [ \begin{matrix}{λ}_{c} \\ {λ}_{p}\end{matrix} ] = [ \begin{matrix}{O}_{{p}_{x}} \\ {O}_{{p}_{y}} \\ {O}_{{p}_{z}}\end{matrix} ] \qquad Equation ( 28 )$$

In yet another aspect, the present invention provides a spatial information acquisition system including the fisheye camera-catadioptric projector structured light system according to the above-described embodiments of the present invention.

The inventors propose a novel omnidirectional structured light system composed of a fisheye camera and a catadioptric projector, which effectively overcomes the fundamental limitation of a narrow field of view inherent in conventional structured light systems. To improve system accuracy, a calibration procedure is introduced that ensures precise convergence even under severe distortion conditions caused by the catadioptric projector, and this is achieved by extending an existing omnidirectional camera model. Experimental results verify the effectiveness of the proposed method, achieving reprojection errors of 0.43 pixels for the camera and 0.49 pixels for the projector. In addition, the practicality of the proposed system is demonstrated through successful dense three-dimensional reconstruction.

The effects of the present invention include the ability to extract three-dimensional data with high accuracy even from objects having complex geometric structures. In addition, by combining a fisheye camera with a catadioptric projector, the present invention enables a wide field of view and precise data acquisition with a simplified hardware configuration compared to conventional systems. These characteristics open up possibilities for effective utilization in various application fields, such as industrial automation, robotic vision, and cultural heritage restoration.

### BRIEF DESCRIPTION OF DRAWINGS

FIG. 1A is a schematic diagram illustrating components of the proposed system and respective coordinate systems thereof.

FIG. 1B is a schematic diagram illustrating a process in which a three-dimensional point X is reprojected onto a location (u′) on an image plane.

FIG. 2A illustrates reprojection results on a projector image after system calibration using an affine transformation, showing an average reprojection error of 1.63.

FIG. 2B illustrates reprojection results on a projector image after system calibration using a perspective transformation, showing an average reprojection error of 0.21.

FIG. 3 illustrates an example showing projector pixel extraction using local homography.

FIG. 4A illustrates a camera image including detected checkerboard corners.

FIG. 4B illustrates a projector image with corner detection.

FIG. 5 illustrates a hardware configuration of the system.

FIG. 6 illustrates an error map of vertical errors of a reconstructed surface.

FIG. 7A illustrates an actual acrylic cylinder.

FIG. 7B illustrates a three-dimensional reconstruction result of the acrylic cylinder.

FIG. 8A illustrates an actual scene to be reconstructed.

FIG. 8B illustrates a three-dimensional reconstruction result of the scene.

FIG. 9 is a diagram illustrating an overall configuration of a fisheye camera-catadioptric projector structured light system according to the present invention.

FIG. 10 is a diagram illustrating a detailed configuration of a fisheye camera according to the present invention.

FIG. 11 is a diagram illustrating a detailed configuration of a convex mirror used in the present invention.

FIG. 12 is a diagram illustrating a detailed configuration of a custom-fabricated convex mirror mount used in the present invention.

FIG. 13 is a diagram illustrating a detailed configuration of a projector used in an embodiment of the present invention.

FIG. 14 is a diagram illustrating a pattern sequence used in an embodiment of the present invention.

### DETAILED DESCRIPTIONS

Hereinafter, embodiments of the present invention will be described in detail with reference to the accompanying drawings. The present invention is capable of various modifications and may take various forms, and thus specific embodiments are illustrated in the drawings and described in detail herein. However, it should be understood that the present invention is not intended to be limited to the specific disclosed embodiments, but rather includes all modifications, equivalents, and alternatives falling within the spirit and scope of the present invention. Like reference numerals refer to like elements throughout the drawings.

In the accompanying drawings, the dimensions of structures are exaggerated relative to actual dimensions for clarity of description. The terminology used herein is for the purpose of describing particular embodiments only and is not intended to limit the present invention. Singular forms include plural forms unless the context clearly indicates otherwise. As used herein, the terms “include,” “includes,” or “including” and “have,” “has,” or “having” specify the presence of stated features, numbers, steps, operations, elements, components, or combinations thereof, but do not preclude the presence or addition of one or more other features, numbers, steps, operations, elements, components, or combinations thereof.

In the context of this specification, terms such as “about” may mean approximately ±1%, ±2%, ±3%, ±4%, ±5%, ±6%, ±7%, ±8%, ±9%, or ±10% of the stated value. In addition, a description of one aspect of the present invention may be equally or similarly applicable to descriptions of other aspects with respect to the same or similar elements or terminology.

Unless otherwise defined, all terms used herein, including technical and scientific terms, have the same meaning as commonly understood by one of ordinary skill in the art to which the present invention pertains. Terms defined in commonly used dictionaries should be interpreted as having meanings consistent with their meanings in the context of the relevant art and the present disclosure, and should not be interpreted in an idealized or overly formal sense unless expressly so defined herein.

A fisheye camera-catadioptric projector structured light system according to an embodiment of the present invention may include a light projection unit including a catadioptric projector configured to project a predetermined light pattern onto an object through reflection or refraction, an imaging unit configured to capture the light pattern projected onto the object using a fisheye camera, and a processing unit configured to compute and derive three-dimensional spatial information of the object based on information related to the light pattern projected by the light projection unit and information related to an image captured by the imaging unit.

In the context of the present specification, the term “fisheye camera” generally refers to an optical device that provides a wide field of view, and in the present invention denotes a camera designed to efficiently capture light patterns formed through reflection or refraction. Such a camera is capable of compensating for distorted views and provides the ability to collect precise pixel-based data over a wide area. In particular, the fisheye camera may be useful for real-time analysis or precise data processing by enabling rapid scanning of large-scale structures or objects having complex shapes.

In the context of the present specification, the term “catadioptric projector” refers to a device that projects a predetermined light pattern by utilizing principles of reflection and refraction, and the type or structure thereof is not particularly limited as long as it functions as a light source. The catadioptric projector may form structured light and uniformly project the structured light onto a surface of an object to provide data to be captured by the fisheye camera. By combining reflection and refraction, the catadioptric projector can reduce distortion of the projected light pattern and stably project the pattern over a wide range.

In the context of the present specification, the term “structured light system” refers to a technology that extracts three-dimensional information by analyzing deformation of a light pattern projected onto an object. In the present invention, a fisheye camera and a catadioptric projector are combined to achieve more efficient and precise three-dimensional data acquisition. Such a system has the potential to process large-scale data at a faster rate than conventional scanning methods.

The role of the light projection unit is to uniformly project a light pattern generated through reflection or refraction onto an object. This enables generation of a high-precision pattern so that information on a surface of the object can be effectively collected. In particular, even for objects having complex shapes or irregular structures, stable pattern projection can reduce data distortion and create an environment in which the fisheye camera can acquire highly reliable data.

The role of the imaging unit is to efficiently capture the light pattern projected by the light projection unit and to collect pattern data deformed on the surface of the object. By using a fisheye camera to capture the light pattern over a wide field of view, data covering a wide viewing angle can be obtained in a single capture. The collected data may then be used for distortion correction and extraction of three-dimensional information.

The role of the processing unit is to compute three-dimensional spatial information of the object based on the light pattern projected by the light projection unit and the image collected by the imaging unit. In this process, the processing unit analyzes and compensates for distortion of the light pattern, and derives accurate three-dimensional coordinates by reflecting characteristics of the deformed pattern on the surface of the object.

In the context of the present specification, with respect to three-dimensional spatial information, the terms “calculate,” “compute,” “extract,” “derive,” or “acquire” are intended to encompass processes of analyzing a surface shape of an object and generating three-dimensional coordinate data by calculating deformation of the projected light pattern. This includes calculating intersections of light rays based on data collected from the fisheye camera and the catadioptric projector, or determining spatial positions and shapes of the object.

By configuring the structured light system according to an embodiment of the present invention as described above, it becomes possible to acquire highly accurate three-dimensional data in various environments. In particular, by combining a fisheye camera with a catadioptric projector, a wide field of view and high-resolution data can be obtained simultaneously, and precise measurement can be achieved even for objects having complex shapes or diverse materials.

A method by which the processing unit computes and/or derives three-dimensional spatial information is not particularly limited. In one embodiment, the processing unit may perform steps of establishing a geometric model of light rays of the structured light system, performing calibration based on the geometric model and a checkerboard having a predetermined pattern, and deriving three-dimensional spatial information of the object based on the calibrated result.

In the context of the present specification, the terms “establishing a geometric model” or “modeling” do not mean creating a new geometric model through human creativity, but rather refer to a passive and/or static process of software-based incorporation of an already existing geometric model, installation of a downloadable function, or implementation of a computable function. This represents a technical concept of setting a mathematical foundation required in the design and implementation of the system, thereby enabling analysis and processing of data.

In the context of the present specification, the term “geometric model” refers to a structure that mathematically represents optical and physical characteristics of the fisheye camera and the catadioptric projector. Such a model includes ray paths, distortion compensation, and coordinate transformations, and provides a computational basis for accurately reconstructing shapes and positions of objects in three-dimensional space.

The role of the step (a) is to mathematically define optical and geometric characteristics of the structured light system, thereby establishing a foundation for extracting three-dimensional spatial information of an object from data collected by the system. This clarifies ray paths and transformation relationships, and helps improve accuracy of calibration and reconstruction processes performed in subsequent steps.

In the context of the present specification, the term “checkerboard” refers to a predetermined light pattern or a physical pattern used for calibration of a structured light system. The pattern has clearly defined corner coordinates and may be used to estimate coordinate transformation relationships between a camera and a projector, as well as to compensate for distortion of the system.

The technical significance of the calibration performed in the step (b) lies in precisely coupling coordinate systems of the fisheye camera and the catadioptric projector, thereby reducing overall system distortion and accurately defining a relationship between a projected light pattern and a captured image. Through this process, precision and reliability of three-dimensional data can be improved, and the applicability of the system in various environments can be enhanced.

The role of the step (c) is to calculate and reconstruct three-dimensional spatial information of an object based on the calibrated geometric model and the collected data. This step focuses on calculating intersections of light rays or compensating for distorted data to accurately represent a shape and a position of the actual object. Through this process, a foundation is provided for ultimately delivering highly accurate three-dimensional data.

A specific method of performing the step (a) is not particularly limited. In one embodiment, the step (a) may include: (a-1) modeling ideal image-plane coordinates (u, v) and three-dimensional spatial coordinates (x, y, z) of an object using Equation (1) and Equation (2); (a-2) modeling a reflected light ray lᵣ parallel to a z-axis of a mirror using the ideal image-plane coordinates (u, v) a depth s of the reflected light ray expressed by Equation (6), and Equation (3); (a-3) modeling a light ray lᵣ′ on a real distorted image plane using the reflected light ray lᵣ, a rotation matrix R expressed by Equation (4-1), a translation vector T expressed by Equation (4-2), and Equation (4); (a-4) modeling real distorted image-plane coordinates (u′, v′) using the light ray lᵣ′ on the real distorted image plane, Equation (5), and Equation (6); (a-5) modeling a transformation relationship between the ideal image-plane coordinates (u, v) and the real distorted image-plane coordinates (u′, v′) based on Equation (7) and Equation (8); and (a-6) modeling a transformation relationship according to Equation (9) by extending an affine transform to a perspective transform through introduction of additional parameters p₃₁ and p₃₂ that reflect distortion caused by a perspective effect in Equation (7) and Equation (8), wherein

$$ρ = {( {u}^{2} + {v}^{2} )}^{\frac{1}{2}} .$$

$$X = [ \begin{matrix}x \\ y \\ Z\end{matrix} ] = λ [ \begin{matrix}u \\ v \\ f ( u , v )\end{matrix} ] \qquad Equation ( 1 )$$

$$f ( u , v ) = {a}_{0} + {a}_{2} {ρ}^{2} + {a}_{3} {ρ}^{3} + {a}_{4} {ρ}^{4} + {a}_{5} {ρ}^{5} \qquad Equation ( 2 )$$

$${l}_{r} = [ \begin{matrix}u \\ v \\ s\end{matrix} ] \qquad Equation ( 3 )$$

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] \qquad Equation ( 4 )$$

$$[ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad Equation ( 4 - 1 )$$

$$[ \begin{matrix}{t}_{1} \\ {t}_{2} \\ {t}_{3}\end{matrix} ] \qquad Equation ( 4 - 2 )$$

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] = [ \begin{matrix}{u}^{′} \\ {v}^{′} \\ 0\end{matrix} ] \qquad Equation ( 5 )$$

$$s = - \frac{{r}_{31} u + {r}_{32} v + {t}_{3}}{{r}_{33}} \qquad Equation ( 6 )$$

$$[ \begin{matrix}{u}^{′} \\ {v}^{′}\end{matrix} ] = [ \begin{matrix}{r}_{11} - \frac{{r}_{13} {r}_{31}}{{r}_{33}} & {r}_{12} - \frac{{r}_{13} {r}_{33}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] \qquad Equation ( 7 )$$

$$[ \begin{matrix}{r}_{11} - \frac{{r}_{13} {r}_{31}}{{r}_{33}} & {r}_{12} - \frac{{r}_{13} {r}_{33}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] = [ \begin{matrix}{a}_{11} & {a}_{12} \\ {a}_{21} & {a}_{22}\end{matrix} ] [ \begin{matrix}u \\ v\end{matrix} ] + [ \begin{matrix}{c}_{1} \\ {c}_{2}\end{matrix} ] \qquad Equation ( 8 )$$

$${λ}_{projection} [ \begin{matrix}{u}^{′} \\ {v}^{′} \\ 1\end{matrix} ] = [ \begin{matrix}{p}_{11} & {p}_{12} & {p}_{13} \\ {p}_{21} & {p}_{22} & {p}_{23} \\ {p}_{31} & {p}_{32} & 1\end{matrix} ] [ \begin{matrix}u \\ v \\ 1\end{matrix} ] \qquad Equation ( 9 )$$

The role of the step (a-1) is to define ideal image-plane coordinates and three-dimensional spatial coordinates of a light source, thereby providing a foundation for an optical and geometric model. In this step, a mathematical representation of light rays is established and basic elements serving as a basis for coordinate system transformation are set, which facilitates data processing and analysis in subsequent steps.

In the context of the present specification, the term “ideal image-plane coordinates” refers to coordinates that can be measured by an image sensor in an ideal state without distortion. These coordinates are used as a reference for compensating for actual distortion, and a relationship with realistic coordinates can be defined through geometric modeling and calibration processes.

The role of the step (a-2) is to model a path of a light ray after the light ray originating from the ideal image plane is reflected by a mirror. In this process, it is assumed that the reflected light ray propagates parallel to a z-axis of the mirror, thereby enabling definition of geometric relationships of the reflected light ray. Through this, the reflection path of the light ray can be mathematically represented and a basis for supporting distortion compensation in subsequent steps can be provided.

The role of the step (a-3) is to model rotation and translation of the reflected light ray until the reflected light ray reaches a real image plane. In this step, a rotation matrix and a translation vector are used to define a transformation relationship between coordinate systems of a camera and a projector. Through this, coordinates on a real distorted image plane can be calculated, thereby enabling precise analysis of data.

In the context of the present specification, the term “rotation matrix” refers to a mathematical representation that indicates a rotational relationship between coordinate systems and defines a rotational transformation about a specific axis. This may play an important role in describing relative orientations of elements within an optical system and in integrating data.

In the context of the present specification, the term “translation vector” refers to a mathematical representation that defines a relative position between coordinate systems and represents movement in a specific direction. This contributes to improving accuracy of coordinate system transformation and helps maintain spatial relationships of data.

The role of the step (a-4) is to calculate coordinates on a real distorted image plane by computing an intersection between a reflected light ray and the image plane. In this process, actual coordinates are estimated based on a mathematical representation of the reflected light ray, thereby enabling acquisition of data that reflects distortion characteristics of the system.

The role of the step (a-5) is to model a transformation relationship between ideal image-plane coordinates and real distorted image-plane coordinates. In this step, a geometric correspondence between the two coordinate systems is defined, thereby providing a mathematical foundation for data correction and three-dimensional reconstruction.

The role of the step (a-6) is to construct a more precise geometric model that reflects perspective effects by extending an affine transform to a perspective transform. In this step, additional parameters are introduced to represent data including realistic distortion, thereby providing a possibility of improving accuracy of the model.

In the context of the present specification, an “affine transform” refers to a mathematical model including linear transformations such as translation, rotation, scaling, and shear. In the context of the present specification, a “perspective transform” refers to a mathematical model that reflects perspective effects and represents proportional size differences between objects at far and near distances.

The technical significance of extending an affine transform to a perspective transform is to define a more complex transformation relationship that goes beyond a simple linear transformation model and includes perspective effects and realistic distortion. Through this, practical accuracy of the system can be improved and applicability in various environments can be enhanced.

A specific method of performing the step (b) is not particularly limited. In one embodiment, the step (b) may include: (b-1) extending an existing omnidirectional camera model using the ideal image-plane coordinates (u, v), the real distorted image-plane coordinates (u′, v′), the parameters p₃₁ and p₃₂, and Equation (10); (b-2) deriving a relationship between ideal image-plane coordinates of a specific point on the object and a three-dimensional position of the point using Equation (11), Equation (12), a rotation matrix R and a translation vector T; (b-3) deriving relational equations expressed by Equation (13a), Equation (13b), and Equation (13c) from Equation (12); (b-4) deriving a relationship expressed by Equation (14) between a calibration parameter vector H expressed by Equation (15) and a calibration data matrix M expressed by Equation (16), and obtaining a solution using a least-squares method; (b-5) deriving coefficients aₙ of Equation (2) using transformation coefficients A, B, C, and D expressed by Equation (18) and Equation (19), which are related to elements of the rotation matrix R, three-dimensional coordinates of checkerboard corners, and elements of the translation vector T, together with Equation (17); (b-6) deriving a residual function r r representing a difference between an actual coordinate and a predicted coordinate using Equation (20), wherein m is one of the real distorted image-plane coordinates (u′, v′), \hat{m} is a coordinate predicted by the model, and k indicates an axis of the coordinate; (b-7) defining an error function E based on the residual function r, the parameters p₃₁ and p₃₂, and Equation (21), and searching for parameters expressed as a set in Equation (22) to minimize the error function; and (b-8) transforming a coordinate system of the light source and a coordinate system of the fisheye camera using Equation (23), and performing nonlinear optimization on parameters to be optimized expressed by Equation (24), wherein: λ is a scale factor; x and y are three-dimensional coordinates of checkerboard corners; superscript i denotes an index of each checkerboard; subscript j denotes an index of each corner of the checkerboard; L is a number of corners of the checkerboard; K is a number of checkerboards used for calibration; P is a projection matrix defined in Equation (9); in Equation (20), k is 1 when m is u′, and 2 when m is v′; an arrow in Equation (23) indicates a direction of coordinate transformation; proj denotes the light source; cam denotes a fisheye camera coordinate system; and board denotes the checkerboard.

$$[ \begin{matrix}{u}^{′} \\ {v}^{′} \\ 1\end{matrix} ] = [ \begin{matrix}1 & 0 & {p}_{13} \\ 0 & 1 & {p}_{23} \\ 0 & 0 & 1\end{matrix} ] [ \begin{matrix}u \\ v \\ 1\end{matrix} ] \qquad Equation ( 10 )$$

$$λ [ \begin{matrix}{u}_{j}^{i} \\ {v}_{j}^{i} \\ f ( {u}_{j}^{i} , {v}_{j}^{i} )\end{matrix} ] = [ \begin{matrix}{r}_{1}^{i} & {r}_{2}^{i} & {r}_{3}^{i} & {t}^{i}\end{matrix} ] [ \begin{matrix}{x}_{j}^{i} \\ {y}_{j}^{i} \\ 0 \\ 1\end{matrix} ] = [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] \qquad Equation ( 11 )$$

$$[ \begin{matrix}{u}_{j}^{i} \\ {v}_{j}^{i} \\ f ( {u}_{j}^{i} , {v}_{j}^{i} )\end{matrix} ] \times [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] = 0 \qquad Equation ( 12 )$$

$${v}_{j}^{i} \cdot ( {r}_{31}^{i} {x}_{j}^{i} + {r}_{32}^{i} {y}_{j}^{i} + {t}_{3}^{i} ) - f ( {u}_{j}^{i} , {v}_{j}^{i} ) \cdot ( {r}_{21}^{i} {x}_{j}^{i} + {r}_{22}^{i} {y}_{j}^{i} + {t}_{2}^{i} ) = 0 \qquad Equation ( 13 a )$$

$$f ( {u}_{j}^{i} , {v}_{j}^{i} ) \cdot ( {r}_{11}^{i} {x}_{j}^{i} + {r}_{12}^{i} {y}_{j}^{i} + {t}_{1}^{i} ) - {u}_{j}^{i} \cdot ( {r}_{31}^{i} {x}_{j}^{i} + {r}_{32}^{i} {y}_{j}^{i} + {t}_{3}^{i} ) = 0 \qquad Equation ( 13 b )$$

$${u}_{j}^{i} \cdot ( {r}_{21}^{i} {x}_{j}^{i} + {r}_{22}^{i} {y}_{j}^{i} + {t}_{2}^{i} ) - {v}_{j}^{i} \cdot ( {r}_{11}^{i} {x}_{j}^{i} + {r}_{12}^{i} {y}_{j}^{i} + {t}_{1}^{i} ) = 0 \qquad Equation ( 13 c )$$

$$M \cdot H = 0 \qquad Equation ( 14 )$$

$$H = {[ {r}_{11}^{i} , {r}_{12}^{i} , {r}_{21}^{i} , {r}_{22}^{i} , {t}_{1}^{i} , {t}_{2}^{i} ]}^{T} \qquad Equation ( 15 )$$

$$M = [ \begin{matrix}- {v}_{1}^{i} {x}_{1}^{i} & - {v}_{1}^{i} {y}_{1}^{i} & {u}_{1}^{i} {x}_{1}^{i} & {u}_{1}^{i} {y}_{1}^{i} & - {v}_{1}^{i} & {u}_{1}^{i} \\ ⋮ & ⋮ & ⋮ & ⋮ & ⋮ & ⋮ \\ - {v}_{L}^{i} {x}_{L}^{i} & - {v}_{L}^{i} {y}_{L}^{i} & {u}_{L}^{i} {x}_{L}^{i} & {u}_{L}^{i} {y}_{L}^{i} & - {v}_{L}^{i} & {u}_{L}^{i}\end{matrix} ] \qquad Equation ( 16 )$$

$$[ \begin{matrix}{A}_{1}^{1} & {{A}_{1}^{1} ( {ρ}_{1}^{1} )}^{2} & {A}_{1}^{1} {( {ρ}_{1}^{1} )}^{3} & {A}_{1}^{1} {( {ρ}_{1}^{1} )}^{4} & - {v}_{1}^{1} & 0 & ⋯ & 0 \\ {C}_{1}^{1} & {{C}_{1}^{1} ( {ρ}_{1}^{1} )}^{2} & {{C}_{1}^{1} ( {ρ}_{1}^{1} )}^{3} & {{C}_{1}^{1} ( {ρ}_{1}^{1} )}^{4} & - {u}_{1}^{1} & 0 & ⋯ & 0 \\ {A}_{2}^{1} & {A}_{2}^{1} {( {ρ}_{2}^{1} )}^{2} & {A}_{2}^{1} {( {ρ}_{2}^{1} )}^{3} & {A}_{2}^{1} {( {ρ}_{2}^{1} )}^{4} & - {v}_{2}^{1} & 0 & ⋯ & 0 \\ {C}_{2}^{1} & {{C}_{2}^{1} ( {ρ}_{2}^{1} )}^{2} & {{C}_{2}^{1} ( {ρ}_{2}^{1} )}^{3} & {{C}_{2}^{1} ( {ρ}_{2}^{1} )}^{4} & - {u}_{2}^{1} & 0 & ⋯ & 0 \\ ⋮ & ⋮ & ⋮ & ⋮ & ⋮ & ⋮ & ⋱ & ⋮ \\ {A}_{L}^{K} & {{A}_{L}^{K} ( {ρ}_{L}^{K} )}^{2} & {{A}_{L}^{K} ( {ρ}_{L}^{K} )}^{3} & {{A}_{L}^{K} ( {ρ}_{L}^{K} )}^{4} & 0 & 0 & ⋯ & - {v}_{L}^{K} \\ {C}_{L}^{K} & {{C}_{L}^{K} ( {ρ}_{L}^{K} )}^{2} & {C}_{L}^{K} {( {ρ}_{L}^{K} )}^{3} & {C}_{L}^{K} {( {ρ}_{L}^{K} )}^{4} & 0 & 0 & ⋯ & - {u}_{L}^{K}\end{matrix} ] [ \begin{matrix}{a}_{0} \\ {a}_{2} \\ {a}_{3} \\ {a}_{4} \\ {t}_{3}^{1} \\ {t}_{3}^{2} \\ ⋮ \\ {t}_{3}^{k}\end{matrix} ] = [ \begin{matrix}{B}_{1}^{1} \\ {D}_{1}^{1} \\ {B}_{2}^{1} \\ {D}_{2}^{1} \\ ⋮ \\ {B}_{L}^{K} \\ {D}_{L}^{K}\end{matrix} ] \qquad Equation ( 17 )$$

$${A}_{j}^{i} = {r}_{21}^{i} {x}_{j}^{i} + {r}_{22}^{i} {y}_{j}^{i} + {t}_{2}^{i} , {B}_{j}^{i} = {v}_{j}^{i} \cdot ( {r}_{31}^{i} {x}_{j}^{i} + {r}_{32}^{i} {y}_{j}^{i} ) \qquad Equation ( 18 )$$

$${C}_{j}^{i} = {r}_{11}^{i} {x}_{j}^{i} + {r}_{12}^{i} {y}_{j}^{i} + {t}_{1}^{i} , {D}_{j}^{i} = {u}_{j}^{i} \cdot ( {r}_{31}^{i} {x}_{j}^{i} + {r}_{32}^{i} {y}_{j}^{i} ) \qquad Equation ( 19 )$$

$$r ( m , \hat{m} , k ) = m - \hat{m} \qquad Equation ( 20 )$$

$${\sum }_{i = 1}^{K} {\sum }_{j = 1}^{L} {\sum }_{k = 1}^{2} {r ( m , \hat{m} ( \hat{U} , {M}_{j}^{i} ) , k )}^{2} + {( {p}_{31} )}^{2} + {( {p}_{32} )}^{2} \qquad Equation ( 21 )$$

$$\hat{U} = [ {r}^{i} , {t}^{i} , a , P ] \qquad Equation ( 22 )$$

$${T}_{proj \to cam} = \frac{1}{K} {\sum }_{i = 1}^{K} ( {{T}_{board \to cam}^{i} ( {T}_{board \to proj}^{i} )}^{- 1} ) \qquad Equation ( 23 )$$

$$\hat{U} = [ {r}_{proj \to cam} , {t}_{proj \to cam} , {a}_{p} , {P}_{p} ] \qquad Equation ( 24 )$$

The role of the step (b-1) is to extend a model by introducing additional parameters p₃₁ and p₃₂ to describe a relationship between ideal image-plane coordinates and real distorted image-plane coordinates. Through this, during subsequent nonlinear optimization for parameter estimation, stable convergence to a global optimum can be achieved without falling into local optima.

The role of the step (b-2) is to derive a relationship between ideal image-plane coordinates and an actual three-dimensional position of a specific point on an object. For this purpose, a transformation model is constructed by applying a rotation matrix (R) and a translation vector (T) to connect three-dimensional positions of the object with coordinates on an image plane. The relational expressions established in this step may be used in a subsequent calibration process and can help improve accuracy of coordinate transformation during optimization.

The role of the step (b-3) is to more precisely define mathematical relationships of calibrated data. Data obtained from captured images are analyzed to derive additional relational expressions based on Equation (12), which are expressed as Equation (13a), Equation (13b), and Equation (13c). In this step, relationships among data can be more clearly defined to improve accuracy of a calibration model, thereby contributing to ensuring stability of an optimization process performed in subsequent steps.

The role of the step (b-4) is to establish a relationship between a calibration parameter vector (H) and a calibration data matrix (M), and to derive an optimal solution using a least-squares method. By applying the least-squares method, errors that may occur in measured data can be minimized, thereby increasing a likelihood that a calibration process of the system is performed more precisely. In addition, uncertainty occurring during computation can be reduced, thereby helping to obtain optimized coordinate transformation results.

The role of the step (b-5) is to derive transformation coefficients A, B, C, and D based on a relationship between three-dimensional coordinates of checkerboard corners and a calibration model, and to calculate coefficients (aₙ) of Equation (2) therefrom. In this process, elements of the rotation matrix (R) and the translation vector (T) are analyzed to more precisely define a transformation relationship in a three-dimensional coordinate system. Through this, distortion of the system can be more accurately reflected, thereby increasing a likelihood of obtaining more reliable results in an optimization process performed in subsequent steps.

The role of the step (b-6) is to derive a residual function (r) that mathematically represents a difference between actually measured image coordinates and image coordinates predicted by the model. This function may be used as an indicator for evaluating accuracy of system calibration and can assist in analyzing differences between the model and actual data. A smaller residual indicates better calibration, and minimizing the residual becomes a goal of the optimization process.

The role of the step (b-7) is to perform a search for parameters to be optimized based on the residual function and an error function (E). In this step, optimization variables including the parameters (p₃₁) and (p₃₂) are adjusted, and a search process is performed so that the entire system can converge to an optimal state. For this purpose, iterative calculations are performed to find a parameter combination having a minimum error, thereby enabling a more stable optimization process.

The role of the step (b-8) is to perform coordinate transformation between the catadioptric projector and the fisheye camera, and to perform nonlinear optimization on parameters to be optimized based thereon. Through the nonlinear optimization process, final accuracy of the calibration model can be improved, and distortion occurring in an actual environment can be more precisely reflected. In this process, differences between the model and actual data can be minimized through iterative calculations.

A specific method of performing the step (c) is not particularly limited. In one embodiment, the step (c) may include: (c-1) deriving a light ray l_{c} originating from a virtual paraboloid center using Equation (25) based on undistorted camera pixel coordinates (u_{c}, v_{c}); (c-2) deriving, in a camera coordinate system, a light ray lₚ from pixel coordinates (uₚ, vₚ) of the light source using Equation (26); and (c-3) deriving Equation (27) or Equation (28) from the camera light ray l_{c} and the light source light ray lₚ, obtaining a scale factor λ_{c} therefrom, and deriving a reconstructed three-dimensional point X in space by substituting the scale factor λ_{c} into Equation (25), wherein Oₚ is an origin of the light source.

$${l}_{c} = {λ}_{c} [ \begin{matrix}{u}_{c} \\ {v}_{c} \\ f ( {u}_{c} , {v}_{c} )\end{matrix} ] = {λ}_{c} [ \begin{matrix}{c}_{1} \\ {c}_{2} \\ {c}_{3}\end{matrix} ] \qquad Equation ( 25 )$$

$${l}_{p} = {λ}_{p} {R}_{proj \to cam} [ \begin{matrix}{u}_{p} \\ {v}_{p} \\ f ( {u}_{p} , {v}_{p} )\end{matrix} ] + {O}_{p} = {λ}_{p} [ \begin{matrix}{p}_{1} \\ {p}_{2} \\ {p}_{3}\end{matrix} ] + {O}_{p} \qquad Equation ( 26 )$$

$$X = {λ}_{c} [ \begin{matrix}{c}_{1} \\ {c}_{2} \\ {c}_{3}\end{matrix} ] = {λ}_{p} [ \begin{matrix}{p}_{1} \\ {p}_{2} \\ {p}_{3}\end{matrix} ] + [ \begin{matrix}{O}_{{p}_{x}} \\ {O}_{{p}_{y}} \\ {O}_{{p}_{z}}\end{matrix} ] \qquad Equation ( 27 )$$

$$[ \begin{matrix}{c}_{1} & - {p}_{1} \\ {c}_{2} & - {p}_{2} \\ {c}_{3} & - {p}_{3}\end{matrix} ] [ \begin{matrix}{λ}_{c} \\ {λ}_{p}\end{matrix} ] = [ \begin{matrix}{O}_{{p}_{x}} \\ {O}_{{p}_{y}} \\ {O}_{{p}_{z}}\end{matrix} ] \qquad Equation ( 28 )$$

The role of the step (c-1) is to derive a direction vector of a light ray originating from a virtual paraboloid center based on undistorted camera pixel coordinates. In this process, a geometric model of the camera is used to determine a direction of a light ray originating from each pixel, thereby defining a path of the light ray in three-dimensional space. Such a vector plays an important role in subsequently finding an intersection with a light ray emitted from a projector and may be a factor that determines accuracy of a reconstructed three-dimensional point.

The role of the step (c-2) is to derive, based on projector pixel coordinates, a direction vector of a light ray emitted from a corresponding pixel in a camera coordinate system. For this purpose, a geometric model of the projector and calibrated parameters are applied to calculate a direction of the light ray and to convert the direction into an expression in the camera coordinate system. In this process, how the light ray actually illuminates and is reflected by an object may be taken into consideration, thereby enabling establishment of a light ray model that is consistent with data collected by the camera.

The role of the step (c-3) is to derive a point in three-dimensional space by calculating an intersection of a light ray originating from the camera and a light ray originating from the projector. For this purpose, an optimal intersection point is determined based on equations of the respective light rays, and the intersection point is converted into a surface position of the object in a three-dimensional coordinate system. This process is a core step of three-dimensional reconstruction, and when accurate calibration is performed, it provides a basis for generating high-precision three-dimensional data.

Functions of the processing unit described above will become more apparent through embodiments described below, and applicability in various environments can be confirmed. The processing unit is not limited to merely deriving three-dimensional data, but may further include functions of compensating for distortion based on input image data and performing optimized coordinate transformation. Through this, stable data processing and accurate depth information may be secured even under various imaging conditions. In addition, as computation algorithms are improved or hardware performance is enhanced, computation speed and data precision may be further improved, thereby providing a basis for use in applications requiring real-time analysis.

Advantages of the structured light system according to the embodiments of the present invention described above include an ability to extract three-dimensional spatial information with high precision even from objects having complex shapes. By applying a geometric model capable of minimizing distortion while securing a wider field of view than conventional methods, more precise data can be derived. In addition, by using a checkerboard during a calibration process, system errors can be reduced, and the system may be designed to operate stably in various environments. These characteristics may be usefully applied in various fields such as industrial automation, medical image analysis, and cultural heritage preservation, and further provide flexibility for extending or optimizing functions of the system as needed.

Meanwhile, a spatial information acquisition method using a fisheye camera and a catadioptric projector according to an embodiment of the present invention may include a first step of projecting, using a catadioptric projector, a predetermined light pattern onto an object through reflection or refraction, a second step of capturing, using the fisheye camera, the light pattern projected onto the object, and a third step of computing and deriving three-dimensional spatial information of the object based on information related to the light pattern and information related to an image captured by the fisheye camera.

The role of the first step is to uniformly project the predetermined light pattern onto the object using the catadioptric projector. In this process, the projector generates a light pattern of a specific shape by utilizing principles of reflection and refraction, thereby forming basic data that can be used to analyze how the pattern is deformed according to a surface shape and material of the object. The quality and uniformity of the light pattern may affect accuracy of data analysis and three-dimensional reconstruction in subsequent steps, and may be designed to be adjustable depending on an environment.

The role of the second step is to efficiently capture the light pattern projected onto the object using the fisheye camera. Since the fisheye camera has a wide field of view, changes in the pattern over a wide area can be recorded in a single capture. In this process, the camera detects how the light pattern is deformed on the surface of the object and converts the detected pattern into digital image data. The captured images may be used as basic data for distortion correction and derivation of three-dimensional information, and may provide a possibility of acquiring reliable data even in environments in which illumination changes or external interference exists.

The role of the third step is to analyze deformation of the captured light pattern and to compute and derive three-dimensional spatial information of the object based thereon. In this process, a geometric model is used to estimate paths of light rays, and coordinate transformation between the camera and the projector is performed to calculate accurate spatial information. In addition, data correction and optimization algorithms may be applied to reduce measurement errors and to derive more precise results.

In one embodiment, wherein the computing and deriving of the three-dimensional spatial information comprises a step (a) of establishing a geometric model of light rays of the structured light system, a step (b) of performing calibration based on the geometric model and a checkerboard having a predetermined pattern, and a step (c) of deriving three-dimensional spatial information of the object based on the calibrated result.

In one embodiment, the step (a) may include: (a-1) modeling ideal image-plane coordinates (u, v) and three-dimensional spatial coordinates (x, y, z) of an object using Equation (1) and Equation (2); (a-2) modeling a reflected light ray lᵣ parallel to a z-axis of a mirror using the ideal image-plane coordinates (u, v) a depth s of the reflected light ray expressed by Equation (6), and Equation (3); (a-3) modeling a light ray lᵣ′ on a real distorted image plane using the reflected light ray lᵣ, a rotation matrix R expressed by Equation (4-1), a translation vector T expressed by Equation (4-2), and Equation (4); (a-4) modeling real distorted image-plane coordinates (u′, v′) using the light ray lᵣ′ on the real distorted image plane, Equation (5), and Equation (6); (a-5) modeling a transformation relationship between the ideal image-plane coordinates (u, v) and the real distorted image-plane coordinates (u′, v′) based on Equation (7) and Equation (8); and (a-6) modeling a transformation relationship according to Equation (9) by extending an affine transform to a perspective transform through introduction of additional parameters p₃₁ and p₃₂ that reflect distortion caused by a perspective effect in Equation (7) and Equation (8), wherein

$$ρ = {( {u}^{2} + {v}^{2} )}^{\frac{1}{2}} .$$

$$X = [ \begin{matrix}x \\ y \\ Z\end{matrix} ] = λ [ \begin{matrix}u \\ v \\ f ( u , v )\end{matrix} ] \qquad Equation ( 1 )$$

$$f ( u , v ) = {a}_{0} + {a}_{2} {ρ}^{2} + {a}_{3} {ρ}^{3} + {a}_{4} {ρ}^{4} + {a}_{5} {ρ}^{5} \qquad Equation ( 2 )$$

$${l}_{r} = [ \begin{matrix}u \\ v \\ s\end{matrix} ] \qquad Equation ( 3 )$$

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] \qquad Equation ( 4 )$$

$$[ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad Equation ( 4 - 1 )$$

$$[ \begin{matrix}{t}_{1} \\ {t}_{2} \\ {t}_{3}\end{matrix} ] \qquad Equation ( 4 - 2 )$$

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] = [ \begin{matrix}{u}^{′} \\ {v}^{′} \\ 0\end{matrix} ] \qquad Equation ( 5 )$$

$$s = - \frac{{r}_{31} u + {r}_{32} v + {t}_{3}}{{r}_{33}} \qquad Equation ( 6 )$$

$$[ \begin{matrix}{u}^{′} \\ {v}^{′}\end{matrix} ] = [ \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] \qquad Equation ( 7 )$$

$$[ \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] = [ \begin{matrix}{a}_{11} & {a}_{12} \\ {a}_{21} & {a}_{22}\end{matrix} ] [ \begin{matrix}u \\ v\end{matrix} ] + [ \begin{matrix}{c}_{1} \\ {c}_{2}\end{matrix} ] \qquad Equation ( 8 )$$

$${λ}_{projection} [ \begin{matrix}{u}^{′} \\ {v}^{′} \\ 1\end{matrix} ] = [ \begin{matrix}{p}_{11} & {p}_{12} & {p}_{13} \\ {p}_{21} & {p}_{22} & {p}_{23} \\ {p}_{31} & {p}_{32} & 1\end{matrix} ] [ \begin{matrix}u \\ v \\ 1\end{matrix} ] \qquad Equation ( 9 )$$

In one embodiment, the step (b) may include: (b-1) extending an existing omnidirectional camera model using the ideal image-plane coordinates (u, v), the real distorted image-plane coordinates (u′, v′), the parameters p₃₁ and p₃₂, and Equation (10); (b-2) deriving a relationship between ideal image-plane coordinates of a specific point on the object and a three-dimensional position of the point using Equation (11), Equation (12), a rotation matrix R and a translation vector T; (b-3) deriving relational equations expressed by Equation (13a), Equation (13b), and Equation (13c) from Equation (12); (b-4) deriving a relationship expressed by Equation (14) between a calibration parameter vector H expressed by Equation (15) and a calibration data matrix M expressed by Equation (16), and obtaining a solution using a least-squares method; (b-5) deriving coefficients aₙ of Equation (2) using transformation coefficients A, B, C, and D expressed by Equation (18) and Equation (19), which are related to elements of the rotation matrix R, three-dimensional coordinates of checkerboard corners, and elements of the translation vector T, together with Equation (17); (b-6) deriving a residual function r r representing a difference between an actual coordinate and a predicted coordinate using Equation (20), wherein m is one of the real distorted image-plane coordinates (u′, v′), m is a coordinate predicted by the model, and k indicates an axis of the coordinate; (b-7) defining an error function E based on the residual function r, the parameters p₃₁ and p₃₂ and Equation (21), and searching for parameters expressed as a set in Equation (22) to minimize the error function; and (b-8) transforming a coordinate system of the light source and a coordinate system of the fisheye camera using Equation (23), and performing nonlinear optimization on parameters to be optimized expressed by Equation (24), wherein: A is a scale factor; x and y are three-dimensional coordinates of checkerboard corners; superscript i denotes an index of each checkerboard; subscript j denotes an index of each corner of the checkerboard; L is a number of corners of the checkerboard; K is a number of checkerboards used for calibration; P is a projection matrix defined in Equation (9); in Equation (20), k is 1 when m is u′, and 2 when m is v′; an arrow in Equation (23) indicates a direction of coordinate transformation; proj denotes the light source; cam denotes a fisheye camera coordinate system; and board denotes the checkerboard.

$$[ \begin{matrix}{u}^{′} \\ {v}^{′} \\ 1\end{matrix} ] = [ \begin{matrix}1 & 0 & {p}_{13} \\ 0 & 1 & {p}_{23} \\ 0 & 0 & 1\end{matrix} ] [ \begin{matrix}u \\ v \\ 1\end{matrix} ] \qquad Equation ( 10 )$$

$$λ [ \begin{matrix}{u}_{j}^{i} \\ {v}_{j}^{i} \\ f ( {u}_{j}^{i} , {v}_{j}^{i} )\end{matrix} ] = [ \begin{matrix}{r}_{1}^{i} & {r}_{2}^{i} & {r}_{3}^{i} & {t}^{i}\end{matrix} ] [ \begin{matrix}{x}_{j}^{i} \\ {y}_{j}^{i} \\ 0 \\ 1\end{matrix} ] = [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] \qquad Equation ( 11 )$$

$$[ \begin{matrix}{u}_{j}^{i} \\ {v}_{j}^{i} \\ f ( {u}_{j}^{i} , {v}_{j}^{i} )\end{matrix} ] \times [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] = 0 \qquad Equation ( 12 )$$

$${v}_{j}^{i} \cdot ( {r}_{31}^{i} {x}_{j}^{i} + {r}_{32}^{i} {y}_{j}^{i} ) + {t}_{3}^{i} ) - f ( {u}_{j}^{i} , {v}_{j}^{i} ) \cdot ( {r}_{21}^{i} {x}_{j}^{i} + {r}_{22}^{i} {y}_{j}^{i} + {t}_{2}^{i} ) = 0 \qquad Equation ( 13 a )$$

$$f ( {u}_{j}^{i} , {v}_{j}^{i} ) \cdot ( {r}_{11}^{i} {x}_{j}^{i} + {r}_{12}^{i} {y}_{j}^{i} + {t}_{1}^{i} ) - {u}_{j}^{i} \cdot ( {r}_{31}^{i} {x}_{j}^{i} + {r}_{32}^{i} {y}_{j}^{i} + {t}_{3}^{i} ) = 0 \qquad Equation ( 13 b )$$

$${u}_{j}^{i} \cdot ( {r}_{21}^{i} {x}_{j}^{i} + {r}_{22}^{i} {y}_{j}^{i} + {t}_{2}^{i} ) - {v}_{j}^{i} \cdot ( {r}_{11}^{i} {x}_{j}^{i} + {r}_{12}^{i} {y}_{j}^{i} + {t}_{1}^{i} ) = 0 \qquad Equation ( 13 c )$$

$$M \cdot H = 0 \qquad Equation ( 14 )$$

$$H = {[ {r}_{11}^{i} , {r}_{12}^{i} , {r}_{21}^{i} , {r}_{22}^{i} , {t}_{1}^{i} , {t}_{2}^{i} ]}^{T} \qquad Equation ( 15 )$$

$$M = [ \begin{matrix}- {v}_{1}^{i} {x}_{1}^{i} & - {v}_{1}^{i} {y}_{1}^{i} & {u}_{1}^{i} {x}_{1}^{i} & {u}_{1}^{i} {y}_{1}^{i} & - {v}_{1}^{i} & {u}_{1}^{i} \\ ⋮ & ⋮ & ⋮ & ⋮ & ⋮ & ⋮ \\ - {v}_{L}^{i} {x}_{L}^{i} & - {v}_{L}^{i} {y}_{L}^{i} & {u}_{L}^{i} {x}_{L}^{i} & {u}_{L}^{i} {y}_{L}^{i} & - {v}_{L}^{i} & {u}_{L}^{i}\end{matrix} ] \qquad Equation ( 16 )$$

$$[ \begin{matrix}{A}_{1}^{1} & {{A}_{1}^{1} ( {ρ}_{1}^{1} )}^{2} & {A}_{1}^{1} {( {ρ}_{1}^{1} )}^{3} & {A}_{1}^{1} {( {ρ}_{1}^{1} )}^{4} & - {v}_{1}^{1} & 0 & ⋯ & 0 \\ {C}_{1}^{1} & {{C}_{1}^{1} ( {ρ}_{1}^{1} )}^{2} & {{C}_{1}^{1} ( {ρ}_{1}^{1} )}^{3} & {{C}_{1}^{1} ( {ρ}_{1}^{1} )}^{4} & - {u}_{1}^{1} & 0 & ⋯ & 0 \\ {A}_{2}^{1} & {A}_{2}^{1} {( {ρ}_{2}^{1} )}^{2} & {A}_{2}^{1} {( {ρ}_{2}^{1} )}^{3} & {A}_{2}^{1} {( {ρ}_{2}^{1} )}^{4} & - {v}_{2}^{1} & 0 & ⋯ & 0 \\ {C}_{2}^{1} & {{C}_{2}^{1} ( {ρ}_{2}^{1} )}^{2} & {{C}_{2}^{1} ( {ρ}_{2}^{1} )}^{3} & {{C}_{2}^{1} ( {ρ}_{2}^{1} )}^{4} & - {u}_{2}^{1} & 0 & ⋯ & 0 \\ ⋮ & ⋮ & ⋮ & ⋮ & ⋮ & ⋮ & ⋱ & ⋮ \\ {A}_{L}^{K} & {{A}_{L}^{K} ( {ρ}_{L}^{K} )}^{2} & {{A}_{L}^{K} ( {ρ}_{L}^{K} )}^{3} & {C}_{L}^{K} {( {ρ}_{L}^{K} )}^{4} & 0 & 0 & ⋯ & - {v}_{L}^{K} \\ {C}_{L}^{K} & {{C}_{L}^{K} ( {ρ}_{L}^{K} )}^{2} & {{C}_{L}^{K} ( {ρ}_{L}^{K} )}^{3} & {{C}_{L}^{K} ( {ρ}_{L}^{K} )}^{4} & 0 & 0 & ⋯ & - {u}_{L}^{K}\end{matrix} ] [ \begin{matrix}{a}_{0} \\ {a}_{2} \\ {a}_{3} \\ {a}_{4} \\ {t}_{3}^{1} \\ {t}_{3}^{2} \\ ⋮ \\ {t}_{3}^{k}\end{matrix} ] = [ \begin{matrix}{B}_{1}^{1} \\ {D}_{1}^{1} \\ {B}_{2}^{1} \\ {D}_{2}^{1} \\ ⋮ \\ {B}_{L}^{K} \\ {D}_{L}^{K}\end{matrix} ] \qquad Equation ( 17 )$$

$${A}_{j}^{i} = {r}_{21}^{i} {x}_{j}^{i} + {r}_{22}^{i} {y}_{j}^{i} + {t}_{2}^{i} , {B}_{j}^{i} = {v}_{j}^{i} \cdot ( {r}_{31}^{i} {x}_{j}^{i} + {r}_{32}^{i} {y}_{j}^{i} ) \qquad Equation ( 18 )$$

$${C}_{j}^{i} = {r}_{11}^{i} {x}_{j}^{i} + {r}_{12}^{i} {y}_{j}^{i} + {t}_{1}^{i} , {D}_{j}^{i} = {u}_{j}^{i} \cdot ( {r}_{31}^{i} {x}_{j}^{i} + {r}_{32}^{i} {y}_{j}^{i} ) \qquad Equation ( 19 )$$

$$r ( m , \hat{m} , k ) = m - \hat{m} \qquad Equation ( 20 )$$

$${\sum }_{i = 1}^{K} {\sum }_{j = 1}^{L} {\sum }_{k = 1}^{2} {r ( m , \hat{m} ( \hat{U} , {M}_{j}^{i} ) , k )}^{2} + {( {p}_{31} )}^{2} + {( {p}_{32} )}^{2} \qquad Equation ( 21 )$$

$$\hat{U} = [ {r}^{i} , {t}^{i} , a , P ] \qquad Equation ( 22 )$$

$${T}_{proj \to cam} = \frac{1}{K} {\sum }_{i = 1}^{K} ( {{T}_{board \to cam}^{i} ( {T}_{board \to proj}^{i} )}^{- 1} ) \qquad Equation ( 23 )$$

$$\hat{U} = [ {r}_{proj \to cam} , {t}_{proj \to cam} , {a}_{p} , {P}_{p} ] \qquad Equation ( 24 )$$

In one embodiment, the step (c) may include: (c-1) deriving a light ray l_{c} originating from a virtual paraboloid center using Equation (25) based on undistorted camera pixel coordinates (u_{c}, v_{c}); (c-2) deriving, in a camera coordinate system, a light ray lₚ from pixel coordinates (uₚ, vₚ) of the light source using Equation (26); and (c-3) deriving Equation (27) or Equation (28) from the camera light ray l_{c} and the light source light ray lₚ, obtaining a scale factor λ_{c} therefrom, and deriving a reconstructed three-dimensional point X in space by substituting the scale factor λ_{c} into Equation (25), wherein Oₚ is an origin of the light source.

$${l}_{c} = {λ}_{c} [ \begin{matrix}{u}_{c} \\ {v}_{c} \\ f ( {u}_{c} , {v}_{c} )\end{matrix} ] = {λ}_{c} [ \begin{matrix}{c}_{1} \\ {c}_{2} \\ {c}_{3}\end{matrix} ] \qquad Equation ( 25 )$$

$${l}_{p} = {λ}_{p} {R}_{proj \to cam} [ \begin{matrix}{u}_{p} \\ {v}_{p} \\ f ( {u}_{p} , {v}_{p} )\end{matrix} ] + {O}_{p} = {λ}_{p} [ \begin{matrix}{p}_{1} \\ {p}_{2} \\ {p}_{3}\end{matrix} ] + {O}_{p} \qquad Equation ( 26 )$$

$$X = {λ}_{c} [ \begin{matrix}{c}_{1} \\ {c}_{2} \\ {c}_{3}\end{matrix} ] = {λ}_{p} [ \begin{matrix}{p}_{1} \\ {p}_{2} \\ {p}_{3}\end{matrix} ] + [ \begin{matrix}{O}_{{p}_{x}} \\ {O}_{{p}_{y}} \\ {O}_{{p}_{z}}\end{matrix} ] \qquad Equation ( 27 )$$

$$[ \begin{matrix}{c}_{1} & - {p}_{1} \\ {c}_{2} & - {p}_{2} \\ {c}_{3} & - {p}_{3}\end{matrix} ] [ \begin{matrix}{λ}_{c} \\ {λ}_{p}\end{matrix} ] = [ \begin{matrix}{O}_{{p}_{x}} \\ {O}_{{p}_{y}} \\ {O}_{{p}_{z}}\end{matrix} ] \qquad Equation ( 28 )$$

Advantages of the spatial information acquisition method according to the embodiments of the present invention described above include the ability to perform stable three-dimensional measurement in various environments. By combining a catadioptric projector with a fisheye camera, a wide field of view can be secured while precise depth information is extracted, and measurement accuracy may be improved through distortion compensation. In addition, since a calibration process using a checkerboard is included, geometric errors of the system can be reduced, and the method may be designed to provide consistent results under various imaging conditions. These characteristics may be applied to fields requiring real-time three-dimensional spatial analysis, and further provide a possibility of additionally applying calibration functions according to shapes and materials of objects to be measured.

Meanwhile, a spatial information acquisition system according to an embodiment of the present invention may include the fisheye camera-catadioptric projector structured light system according to the above-described embodiments of the present invention. The spatial information acquisition system may be applied to various applications. For example, when used for six-degree-of-freedom (6D) pose estimation, the system may help simultaneously estimate a position and an orientation of a target object. By projecting precise light patterns using the catadioptric projector and acquiring data over a wide field of view using the fisheye camera, reliable pose estimation may be achieved from various viewing angles. Accordingly, the system may be applied to industrial automation, robotic manipulation, augmented reality (AR) and virtual reality (VR) systems, and in particular may provide a basis for precisely performing object tracking and interaction in complex environments.

When used in robotics, the system may help improve spatial perception and environmental understanding capabilities of autonomous mobile robots or industrial robots. Compared to conventional depth sensors, the system enables acquisition of structured light-based data with a wider field of view and higher precision, thereby increasing a likelihood that a robot can perform obstacle avoidance, path planning, and tasks in dynamic environments. In addition, the system may contribute to improving positional accuracy of robot arms or grippers, and may be reliably used in various applications such as collaborative robots and unmanned transportation systems.

When used for three-dimensional scanning, the system enables more precise shape measurement compared to conventional methods, and in particular may more effectively acquire depth information of objects having different reflectivities or complex surfaces. Compared to general three-dimensional scanners, the present system may have an advantage of rapidly scanning a wide area, and may be used to generate more precise models by combining multiple views. These characteristics may be usefully applied in fields such as cultural heritage preservation, medical image analysis, and digital twin construction.

In addition, non-limiting examples of applicable applications may include object recognition and classification, automated quality inspection, augmented reality (AR) and virtual reality (VR), motion capture systems, medical image analysis, smart manufacturing processes, autonomous vehicles, drone navigation, smart city infrastructure monitoring, three-dimensional mapping of construction sites, human body scanning and fitness analysis, sports performance analysis, biometric authentication and security, warehouse logistics automation, remote collaboration and remote maintenance, agricultural crop growth monitoring, motion capture for animation and game production, environmental monitoring and meteorological data collection, underwater and space exploration, development of assistive devices for persons with disabilities, and the like.

An advantage of the spatial information acquisition system is that three-dimensional spatial data can be acquired with high precision in various environments. Compared to conventional approaches, distortion compensation is facilitated, and a structured light-based measurement method using a catadioptric projector may provide high reliability. In addition, by using a fisheye camera, a wide field of view can be secured, allowing more data to be collected even with a single capture, and measurement errors may be reduced through a calibration process.

Hereinafter, embodiments of the present invention will be described. However, the embodiments described below are merely some embodiments of the present invention, and the scope of the present invention is not limited to the embodiments described below.

### Geometric Modeling

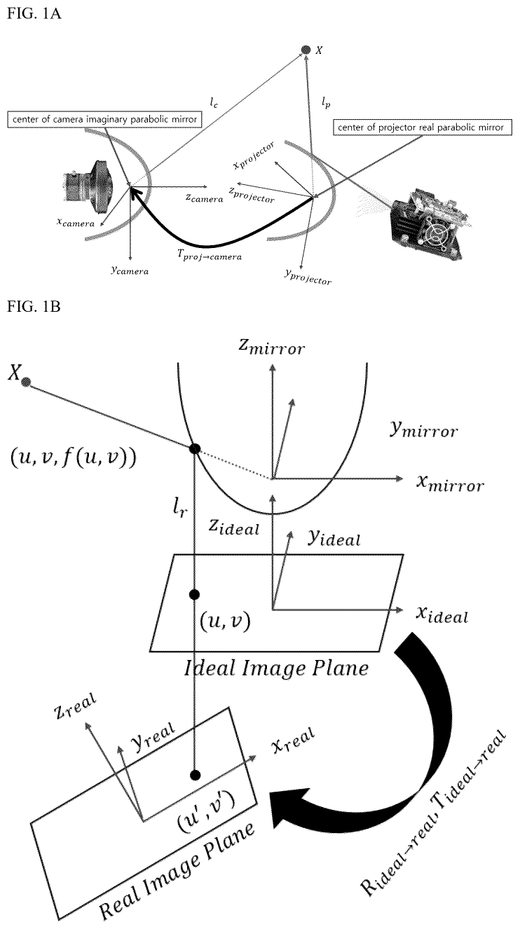

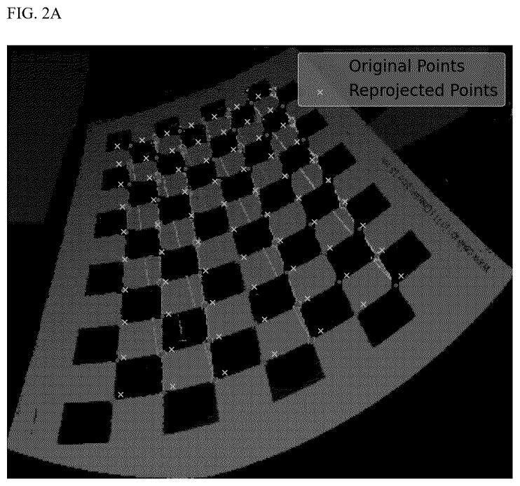

The proposed system is composed of a fisheye camera and a catadioptric projector including a parabolic mirror. The camera and the projector are arranged to face each other, with the parabolic mirror positioned therebetween. Although no physical mirror is present in front of the camera, it is assumed, as illustrated in FIG. 1A, that a virtual parabolic mirror exists. Under this assumption, a unified geometric model that can be applied to both the camera and the projector can be established.

As a camera model, a catadioptric camera model described in the reference literature is adopted, in which a mirror shape is represented in a polynomial form. Through this representation, an arbitrary mirror can be regarded as a quasi-parabolic mirror. The quasi-parabolic mirror has a property in which a reflected light ray directed from a point in a world coordinate system toward a mirror center becomes parallel to a mirror axis. For a more intuitive understanding, reference may be made to FIG. 1B. Accordingly, when a point X in the world coordinate system and a pixel u on an ideal image plane are perfectly aligned with the mirror axis, the following Equation (1) is satisfied.

$$X = [ \begin{matrix}x \\ y \\ Z\end{matrix} ] = λ [ \begin{matrix}u \\ v \\ f ( u , v )\end{matrix} ] \qquad Equation ( 1 )$$

Herein,

$$ρ = {( {u}^{2} + {v}^{2} )}^{\frac{1}{2}} ,$$

and the function is expressed by the following Equation (2).

$$f ( u , v ) = {a}_{0} + {a}_{2} {ρ}^{2} + {a}_{3} {ρ}^{3} + {a}_{4} {ρ}^{4} + {a}_{5} {ρ}^{5} \qquad Equation ( 2 )$$

A reflected light ray lᵣ parallel to a z-axis of the mirror may be formulated as shown in the following Equation (3).

$${l}_{r} = [ \begin{matrix}u \\ v \\ s\end{matrix} ] \qquad Equation ( 3 )$$

The real image plane is not identical to the ideal image plane due to misalignment of a lens, a mirror, and other components. Accordingly, the real image plane is related to the ideal image plane through a transformation defined by a rotation matrix R∈ [symbol] ^{3×3} and a translation vector T∈ [symbol] ^{3×1}.

A process of transforming the reflected light ray lᵣ to the real image plane is expressed as shown in the following Equation (4).

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] \qquad Equation ( 4 )$$

Next, an intersection between the reflected light ray lᵣ′ and the real image plane, that is, a real distorted image coordinate u′∈ [symbol] ², can be calculated as shown in the following Equations (5) and (6).

$${l}_{r}^{′} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}u \\ v \\ s\end{matrix} ] + [ \begin{matrix}{t}_{1} \\ {t}_{2} \\ {t}_{3}\end{matrix} ] = [ \begin{matrix}{u}^{′} \\ {v}^{′} \\ 0\end{matrix} ] \qquad Equation ( 5 )$$

$$s = - \frac{{r}_{31} u + {r}_{32} v + {t}_{3}}{{r}_{33}} \qquad Equation ( 6 )$$

Finally, a transformation from an ideal image-plane coordinate u to the real distorted image-plane coordinate u′ can be expressed as shown in the following Equations (7) and (8).

$$[ \begin{matrix}{u}^{′} \\ {v}^{′}\end{matrix} ] = [ \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] \qquad Equation ( 7 )$$

$$[ \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} ] [ \begin{matrix}u \\ v \\ 1\end{matrix} ] = [ \begin{matrix}{a}_{11} & {a}_{12} \\ {a}_{21} & {a}_{22}\end{matrix} ] [ \begin{matrix}u \\ v\end{matrix} ] + [ \begin{matrix}{c}_{1} \\ {c}_{2}\end{matrix} ] \qquad Equation ( 8 )$$

Equation (8) accurately describes the model under ideal conditions; however, in practice, when applied to a catadioptric projector system, it has been observed that severe distortion causes a parameter estimation process to fall into local minima. To overcome this limitation, extending an affine transformation to a perspective transformation provides additional flexibility in a parameter space, thereby improving convergence.

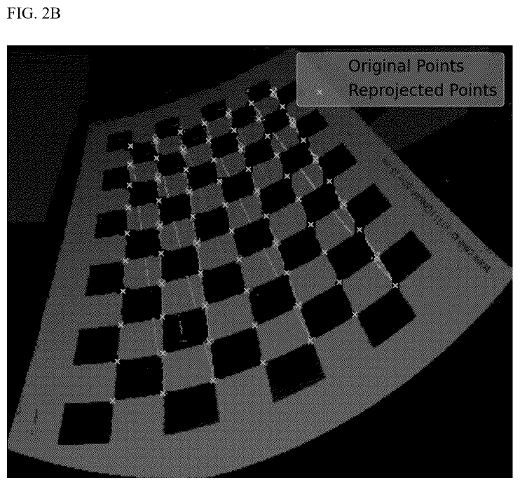

FIGS. 2A and 2B illustrate reprojection results simulated in Blender. As shown in FIGS. 2A and 2B, the affine transformation fails to perform accurate calibration. In contrast, when a perspective transformation is applied, the model overcomes local minima and performs more robust and accurate calibration. Based on these results, the model proposed in the present invention is defined as shown in the following Equation (9).

$${λ}_{projection} [ \begin{matrix}{u}^{′} \\ {v}^{′} \\ 1\end{matrix} ] = [ \begin{matrix}{p}_{11} & {p}_{12} & {p}_{13} \\ {p}_{21} & {p}_{22} & {p}_{23} \\ {p}_{31} & {p}_{32} & 1\end{matrix} ] [ \begin{matrix}u \\ v \\ 1\end{matrix} ] \qquad Equation ( 9 )$$

### Calibration Procedure

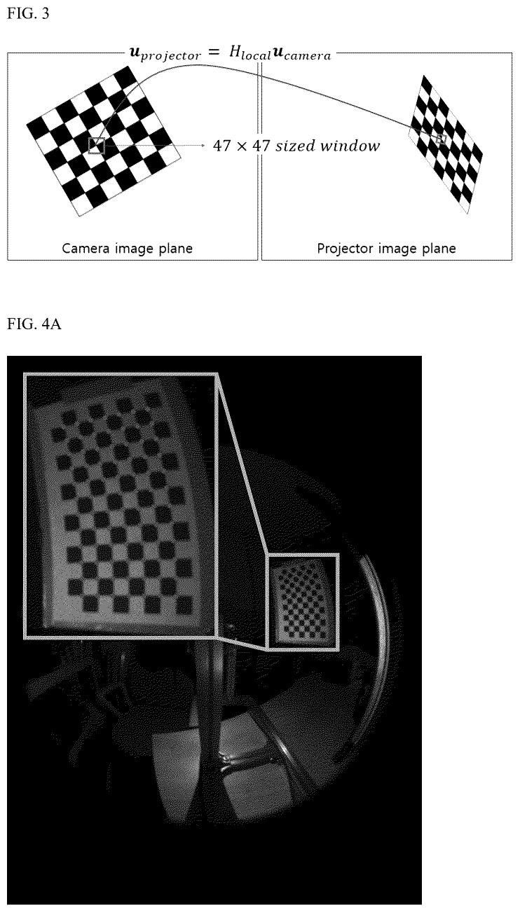

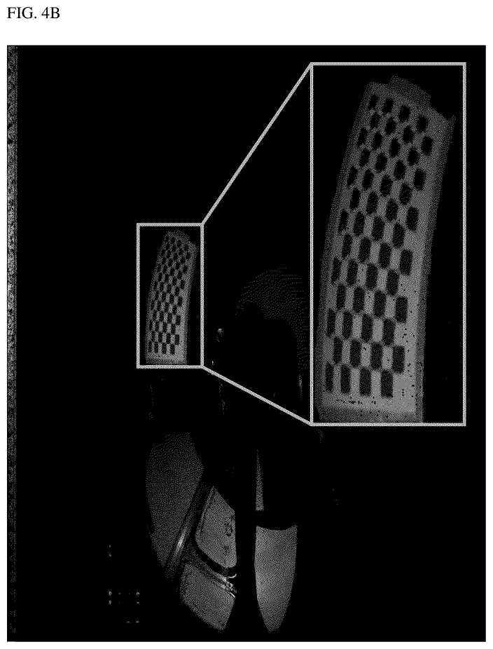

This section describes a calibration procedure of the proposed system. In order to calibrate the projector, it is important to accurately extract projector pixels using multiple fringe images. The following outlines a methodology described in the reference literature. Projector pixels can be robustly classified using binary patterns and their complementary binary patterns. After mapping projector pixels to camera pixels, checkerboard corners can be robustly extracted on a projector image plane using local homography. As illustrated in FIG. 3, a square window is used to estimate each local homography. Through experimental analysis, it was concluded that a window size of 47×47 is appropriate for the proposed approach. To further enhance robustness, noise is removed using a RANSAC algorithm. Actual examples of detecting checkerboard corners in projector images are shown in FIGS. 4A and 4B. As can be seen in FIG. 4B, although some pixels are incorrectly classified, confirms that the checkerboard corners are accurately detected.

### Individual Camera and Projector Calibration

In this step, intrinsic parameters of the camera and the projector are estimated, and a transformation between the camera and the checkerboard as well as a transformation between the projector and the checkerboard are jointly estimated. A calibration process following conventional methodologies proceeds by first performing linear estimation and then refining the results through nonlinear optimization.

### (1) Linear Estimation:

In a first step, parameters are calculated using linear estimation, which are then used as initial values for subsequent nonlinear optimization. To initiate linear estimation, the calibration process requires a distortion center, which is expressed as p₁₃ and p₂₃ in Equation (9).

For the camera, an image center can be appropriately used as an approximation of the distortion center. However, for the projector, since distortion is relatively large, a more precise approach is required and an accurate distortion center must be identified. For this purpose, all projector images are overlaid to generate a composite image, and a center of the composite image is determined.

Thereafter, a process is performed in which real distorted pixel coordinates u′ are first transformed into ideal pixel coordinates u, and this transformation process is defined by Equation (9). A general initial transformation matrix for a typical camera used for initial value estimation is expressed by the following Equation (10a). However, when a projector having different physical pixel densities in vertical and horizontal directions is used, an additional constant for compensating pixel density may be further considered, as expressed in the following Equation (10b).

$$[ \begin{matrix}{u}^{′} \\ {v}^{′} \\ 1\end{matrix} ] = [ \begin{matrix}1 & 0 & {p}_{13} \\ 0 & 1 & {p}_{23} \\ 0 & 0 & 1\end{matrix} ] [ \begin{matrix}u \\ v \\ 1\end{matrix} ] \qquad Equation ( 10 a )$$

$$[ \begin{matrix}{u}_{p}^{′} \\ {v}_{p}^{′} \\ 1\end{matrix} ] = [ \begin{matrix}0.5 & 0 & {c}_{1} \\ 0 & 1 & {c}_{2} \\ 0 & 0 & 1\end{matrix} ] [ \begin{matrix}{u}_{p} \\ {v}_{p} \\ 1\end{matrix} ] \qquad Equation ( 10 b )$$

Subsequently, three-dimensional coordinates of checkerboard corners and corresponding extrinsic parameters of each checkerboard, that is, a rotation matrix

$${R}_{i} = [ \begin{matrix}{r}_{1}^{i} & {r}_{2}^{i} & {r}_{3}^{i}\end{matrix} ]$$

and a translation vector tⁱ, can be expressed as shown in the following Equation (11).

$$λ [ \begin{matrix}{u}_{j}^{i} \\ {v}_{j}^{i} \\ f ( {u}_{j}^{i} , {v}_{j}^{i} )\end{matrix} ] = [ \begin{matrix}{r}_{1}^{i} & {r}_{2}^{i} & {r}_{3}^{i} & {t}^{i}\end{matrix} ] [ \begin{matrix}{x}_{j}^{i} \\ {y}_{j}^{i} \\ 0 \\ 1\end{matrix} ] = [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] \qquad Equation ( 11 )$$

Here, the superscript i denotes each checkerboard, and the subscript j denotes each corner of the checkerboard and corresponding pixel coordinates of the projector on the ideal image plane. To eliminate a scale factor, both sides of the equation are multiplied by X.

$$[ \begin{matrix}{u}_{j}^{i} \\ {v}_{j}^{i} \\ f ( {u}_{j}^{i} , {v}_{j}^{i} )\end{matrix} ] \times [ \begin{matrix}{r}_{1}^{i} & {r}_{2}^{i} & {t}^{i}\end{matrix} ] [ \begin{matrix}{x}_{j}^{i} \\ {y}_{j}^{i} \\ 1\end{matrix} ] = 0 \qquad Equation ( 12 )$$

Using each row of Equation (12), three homogeneous equations are obtained for each checkerboard.

$${v}_{j}^{i} \cdot ( {r}_{31}^{i} {x}_{j}^{i} + {r}_{32}^{i} {y}_{j}^{i} + {t}_{3}^{i} ) - f ( {u}_{j}^{i} , {v}_{j}^{i} ) \cdot ( {r}_{21}^{i} {x}_{j}^{i} + {r}_{22}^{i} {y}_{j}^{i} + {t}_{2}^{i} ) = 0 \qquad Equation ( 13 a )$$

$$f ( {u}_{j}^{i} , {v}_{j}^{i} ) \cdot ( {r}_{11}^{i} {x}_{j}^{i} + {r}_{12}^{i} {y}_{j}^{i} + {t}_{1}^{i} ) - {u}_{j}^{i} \cdot ( {r}_{31}^{i} {x}_{j}^{i} + {r}_{32}^{i} {y}_{j}^{i} + {t}_{3}^{i} ) = 0 \qquad Equation ( 13 b )$$

$${u}_{j}^{i} \cdot ( {r}_{21}^{i} {x}_{j}^{i} + {r}_{22}^{i} {y}_{j}^{i} + {t}_{2}^{i} ) - {v}_{j}^{i} \cdot ( {r}_{11}^{i} {x}_{j}^{i} + {r}_{12}^{i} {y}_{j}^{i} + {t}_{1}^{i} ) = 0 \qquad Equation ( 13 c )$$

From information of the calibration board,

$${x}_{j}^{i} and {y}_{j}^{i}$$

are known, and pixel coordinates

$${u}_{j}^{i} and {v}_{j}^{i}$$

are also known. Based on this, Equation (13c) is accumulated for all points of each calibration board, and by solving the following equation, unknown parameters

$${r}_{11}^{i} , {r}_{12}^{i} , {r}_{21}^{i} , {r}_{22}^{i} , {t}_{1}^{i} , {t}_{2}^{i}$$

can be estimated.

$$M \cdot H = 0 \qquad Equation ( 14 )$$

$$Here , H = {[ {r}_{11}^{i} , {r}_{12}^{i} , {r}_{21}^{i} , {r}_{22}^{i} , {t}_{1}^{i} , {t}_{2}^{i} ]}^{T} and \qquad Equation ( 15 )$$

$$M = [ \begin{matrix}- {v}_{1}^{i} {x}_{1}^{i} & - {v}_{1}^{i} {y}_{1}^{i} & {u}_{1}^{i} {x}_{1}^{i} & {u}_{1}^{i} {y}_{1}^{i} & - {v}_{1}^{i} & {u}_{1}^{i} \\ ⋮ & ⋮ & ⋮ & ⋮ & ⋮ & ⋮ \\ - {v}_{L}^{{i}_{}} {x}_{L}^{i} & - {v}_{L}^{{i}_{}} {y}_{L}^{i} & {u}_{L}^{i} {x}_{L}^{i} & {u}_{L}^{i} {y}_{L}^{i} & - {v}_{L}^{i} & {u}_{L}^{i}\end{matrix} ] \qquad Equation ( 16 )$$

where L denotes the number of corners on each checkerboard, which is implicitly included in the matrix M. A linear estimation of H can be achieved by minimizing ∥M·H∥₂, which can be efficiently performed by applying a singular value decomposition (SVD) algorithm to Equation (14).

Using the estimated values

$${r}_{11}^{i} , {r}_{12}^{i} , {r}_{21}^{i} , {r}_{22}^{i} ,$$

parameters

$${r}_{31}^{i} and {r}_{32}^{i}$$

can be calculated by applying orthonormality constraints on rotation vectors. Thereafter, a last column vector

$${r}_{3}^{i}$$

is derived from a vector cross product of

$${r}_{1}^{i} and {r}_{2}^{i} .$$

By substituting the estimated values

$${r}_{11}^{i} , {r}_{12}^{i} , {r}_{21}^{i} , {r}_{22}^{i} , {r}_{31}^{i} , {r}_{32}^{i} , {t}_{1}^{i} , {t}_{2}^{i}$$

into Equation (13a) and Equation (13b), polynomial coefficients shown in Equation (2) and an extrinsic parameter

$${t}_{3}^{i}$$

can be estimated.

To integrate observations obtained from all K calibration checkerboards, all equations can be stacked as follows.

$$[ \begin{matrix}{A}_{1}^{1} & {{A}_{1}^{1} ( {ρ}_{1}^{1} )}^{2} & {{A}_{1}^{1} ( {ρ}_{1}^{1} )}^{3} & {{A}_{1}^{1} ( {ρ}_{1}^{1} )}^{4} & - {v}_{1}^{1} & 0 & ⋯ & 0 \\ {C}_{1}^{1} & {{C}_{1}^{1} ( {ρ}_{1}^{1} )}^{2} & {{C}_{1}^{1} ( {ρ}_{1}^{1} )}^{3} & {{C}_{1}^{1} ( {ρ}_{1}^{1} )}^{4} & - {u}_{1}^{1} & 0 & ⋯ & 0 \\ {A}_{2}^{1} & {{A}_{2}^{1} ( {ρ}_{2}^{1} )}^{2} & {{A}_{2}^{1} ( {ρ}_{2}^{1} )}^{3} & {{A}_{2}^{1} ( {ρ}_{2}^{1} )}^{4} & - {v}_{2}^{1} & 0 & ⋯ & 0 \\ {C}_{2}^{1} & {{C}_{2}^{1} ( {ρ}_{2}^{1} )}^{2} & {{C}_{2}^{1} ( {ρ}_{2}^{1} )}^{3} & {{C}_{2}^{1} ( {ρ}_{2}^{1} )}^{4} & - {u}_{2}^{1} & 0 & ⋯ & 0 \\ ⋮ & ⋮ & ⋮ & ⋮ & ⋮ & ⋮ & ⋱ & ⋮ \\ {A}_{L}^{K} & {{A}_{L}^{K} ( {ρ}_{L}^{K} )}^{2} & {{A}_{L}^{K} ( {ρ}_{L}^{K} )}^{3} & {{A}_{L}^{K} ( {ρ}_{L}^{K} )}^{4} & 0 & 0 & ⋯ & - {v}_{L}^{K} \\ {C}_{L}^{K} & {{C}_{L}^{K} ( {ρ}_{L}^{K} )}^{2} & {{C}_{L}^{K} ( {ρ}_{L}^{K} )}^{3} & {{C}_{L}^{K} ( {ρ}_{L}^{K} )}^{4} & 0 & 0 & ⋯ & - {u}_{L}^{K}\end{matrix} ] [ \begin{matrix}{a}_{0} \\ {a}_{2} \\ {a}_{3} \\ {a}_{4} \\ {t}_{3}^{1} \\ {t}_{3}^{2} \\ ⋮ \\ {t}_{3}^{k}\end{matrix} ] = [ \begin{matrix}{B}_{1}^{1} \\ {D}_{1}^{1} \\ {B}_{2}^{1} \\ {D}_{2}^{1} \\ ⋮ \\ {B}_{L}^{K} \\ {D}_{L}^{K}\end{matrix} ] \qquad Equation ( 17 )$$

$$wherein : {A}_{j}^{i} = {r}_{21}^{i} {x}_{j}^{i} + {r}_{22}^{i} {y}_{j}^{i} + {t}_{2}^{i} , {B}_{j}^{i} = {v}_{j}^{i} \cdot ( {r}_{31}^{i} {x}_{j}^{i} + {r}_{32}^{i} {y}_{j}^{i} ) \qquad Equation ( 18 )$$

$${C}_{j}^{i} = {r}_{11}^{i} {x}_{j}^{i} + {r}_{12}^{i} {y}_{j}^{i} + {t}_{1}^{i} , {D}_{j}^{i} = {u}_{j}^{i} \cdot ( {r}_{31}^{i} {x}_{j}^{i} + {r}_{32}^{i} {y}_{j}^{i} ) \qquad Equation ( 19 )$$

By solving Equation (17) using a pseudoinverse, all initial values required for performing nonlinear calibration (refinement) can be obtained.

### (2) Nonlinear Calibration

Nonlinear calibration based on maximum likelihood estimation aims to improve accuracy of initial parameter estimation. To increase convergence speed and improve overall performance, a residual function is used to increase a number of observations, which may provide improved results compared to a conventional Euclidean norm-based distance approach. The residual function is defined as follows.

$$r ( m , \hat{m} , k ) = m - \hat{m} \qquad Equation ( 20 )$$

Here, m represents u′ when k=1 or v′ when k=2 on the real image plane. Using this function, the estimated parameters minimize the following error function.

$${\sum }_{i = 1}^{K} {\sum }_{j = 1}^{L} {\sum }_{k = 1}^{2} {r ( m , \hat{m} ( \hat{U} , {M}_{j}^{i} ) , k )}^{2} + {( {p}_{31} )}^{2} + {( {p}_{32} )}^{2} \qquad Equation ( 21 )$$

The terms (p₃₁)² and (p₃₂)² are introduced to prevent overfitting that may occur when transitioning from an affine transformation to a perspective transformation. Furthermore,

$$\hat{U} = [ {r}^{i} , {t}^{i} , a , P ] \qquad Equation ( 22 )$$

represents a set of parameters adjusted during an optimization process.

In this formulation, the following are defined as:
K: a number of checkerboards;
L: a number of corners on each checkerboard;
M^{ij}: three-dimensional coordinates of checkerboard corners in a checkerboard coordinate system;
rᵢ: a rotation vector of each checkerboard;
tᵢ: a translation vector of each checkerboard;
a: polynomial coefficients shown in Equation (2); and
P: a projection matrix defined in Equation (9).

The error function E is minimized using a Levenberg-Marquardt algorithm.

### System Calibration

The goal of system calibration is to estimate a transformation between coordinate systems of a projector and a camera, and to precisely adjust intrinsic parameters of the projector. After individually calibrating the camera and the projector, homogeneous transformations between the projector and a checkerboard and between the camera and the checkerboard are determined. Thereafter, a transformation from the projector to the camera coordinate system is calculated by multiplying an inverse of the homogeneous transformation of the projector with the homogeneous transformation of the camera.

When K checkerboard observations are given, an initial transformation for nonlinear refinement is set as an average transformation over all observations.

$${T}_{proj \to cam} = \frac{1}{K} {\sum }_{i = 1}^{K} ( {{T}_{board \to cam}^{i} ( {T}_{board \to proj}^{i} )}^{- 1} ) \qquad Equation ( 23 )$$

A catadioptric projector system exhibits significantly larger distortion compared to a fisheye camera. To address this, three-dimensional coordinates of checkerboard corners obtained during the fisheye camera calibration process are used as reference points. Thereafter, the checkerboard corners are initially reprojected onto an actual projector image plane using the previously estimated parameters and the average transformation between the projector and the camera.

The residual function and the error function defined in Equation (20) and Equation (21) are applied only on the projector image plane. Unlike the previous definition, three-dimensional coordinates Mᵢⱼ of checkerboard corners are no longer expressed in a checkerboard coordinate system, but rather in the camera coordinate system. Parameters to be optimized, denoted by U*, are as follows.

$$\hat{U} = [ {r}_{proj \to cam} , {t}_{proj \to cam} , {a}_{p} , {P}_{p} ] \qquad Equation ( 24 )$$

Herein, symbols are defined as follows:
Mᵢⱼ: three-dimensional coordinates of checkerboard corners in the camera coordinate system;
r_{proj→cam}: a rotation vector from the projector to the camera;
t_{proj→cam}: a translation vector from the projector to the camera;
aₚ: polynomial coefficients of the projector; and
Pₚ: a projection matrix of the projector.

### Three-Dimensional Reconstruction

Three-dimensional reconstruction of a scene is performed by determining an intersection between a light ray projected from the projector and a light ray captured by the camera. After completion of the calibration process, the system can be simplified into a pair of parabolic mirrors, each projecting light rays from its own center.

A light ray l_{c}, which originates from a virtual parabolic mirror center of the camera and corresponds to an undistorted camera pixel u_{c}, can be expressed as follows.

$${l}_{c} = {λ}_{c} [ \text{} \begin{matrix}{u}_{c} \\ {v}_{c} \\ f ( {u}_{c} , {v}_{c} )\end{matrix} ] = {λ}_{c} [ \text{} \begin{matrix}{c}_{1} \\ {c}_{2} \\ {c}_{3}\end{matrix} \text{} ] \qquad Equation ( 25 )$$

Similarly, in the camera coordinate system, a light ray lₚ projected from an actual parabolic mirror center of the projector is defined by an ideal projector pixel uₚ, a rotation matrix R_{proj→cam}, and a center position Oₚ of the projector, as expressed below.

$${l}_{p} = {λ}_{p} {R}_{proj \to cam} [ \text{} \begin{matrix}{u}_{p} \\ {v}_{p} \\ f ( {u}_{p} , {v}_{p} )\end{matrix} ] + {O}_{p} = {λ}_{p} [ \text{} \begin{matrix}{p}_{1} \\ {p}_{2} \\ {p}_{3}\end{matrix} \text{} ] + {O}_{p} \qquad Equation ( 26 )$$

A three-dimensional position of an object point in the scene is determined by a relationship between the two light rays.

$$X = {λ}_{c} [ \text{} \begin{matrix}{c}_{1} \\ {c}_{2} \\ {c}_{3}\end{matrix} \text{} ] = {λ}_{p} [ \text{} \begin{matrix}{p}_{1} \\ {p}_{2} \\ {p}_{3}\end{matrix} \text{} ] + [ \text{} \begin{matrix}{O}_{{p}_{x}} \\ {O}_{{p}_{y}} \\ {O}_{{p}_{z}}\end{matrix} \text{} ] \qquad Equation ( 27 )$$

By rearranging the equation, a linear system of equations for obtaining scaling factors λ_{c} and λ_{P} can be obtained.

$$[ \text{} \begin{matrix}{c}_{1} & - {p}_{1} \\ {c}_{2} & - {p}_{2} \\ {c}_{3} & - {p}_{3}\end{matrix} \text{} ] [ \begin{matrix}{λ}_{c} \\ {λ}_{p}\end{matrix} \text{} ] = [ \text{} \begin{matrix}{O}_{{p}_{x}} \\ {O}_{{p}_{y}} \\ {O}_{{p}_{z}}\end{matrix} \text{} ] \qquad Equation ( 28 )$$

### Experimental Results

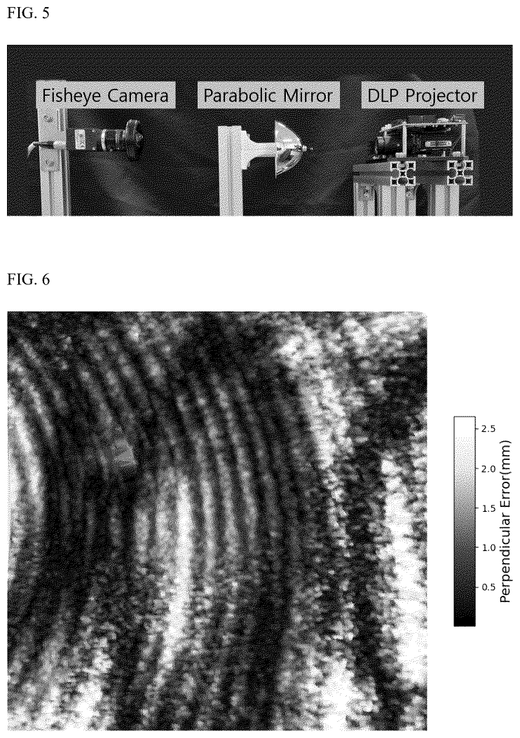

An experimental setup is shown in FIG. 5, and includes a Teledyne FLIR BFS-U3-28S5C-C camera having a resolution of 1936×1464 pixels, a FUJINON FE185C057HA-1 fisheye lens, an EKB Technologies DPM-E4500MKII-Green (525 nm) laser projector having a resolution of 912×1140 pixels and employing on-axis alignment, and a parabolic mirror. For Gray encoding, three binary fringe patterns and corresponding complementary binary fringe patterns were used, and to encode phase information of projector pixels, 48 sinusoidal patterns were used in each of horizontal and vertical directions. In addition, two fine fringe patterns were further employed to more precisely classify pixels.

### Calibration Results

### (1) Camera Calibration Results

Camera calibration was performed using a total of 47 images, of which 18 images were taken from a captured fringe image set and the remaining 29 images were separately acquired for camera calibration. As a result of evaluation using the 18 images taken from the captured fringe image set, a final average reprojection error was measured to be 0.43 pixels. Detailed calibration results for the camera are presented in Table 1 and Table 2 (Camera Calibration Results).

TABLE 1
Perspective Transform Matrix

| P₁₁ | P₁₂ | P₁₃ |
|---|---|---|
| 1.01 | −0.020 | 955.67 |

| P₂₁ | P₂₂ | P₂₃ |
|---|---|---|
| 0.019 | 1.01 | 711.79 |

| \|P₃₁\| | \|P₃₂\| | P₃₃ |
|---|---|---|
| <10⁻⁶ | <10⁻⁵ | 1 |

### (2) Projector Calibration Results

TABLE 2
Polynomial Coefficients

| a₀ | a₁ | a₂ | \|a₃\| | \|a₄\| |
|---|---|---|---|---|
| 395.57 | 0 | −0.0001 | <10⁻⁶ | <10⁻⁸ |

Projector calibration was performed using 18 sets of captured fringe images. Calibration results, including extrinsic parameters required to transform from the projector coordinate system to the camera coordinate system, are summarized in Table 3, Table 4, and Table 5 (Projector Calibration Results). The fact that absolute values of P₃₁ and P₃₂ are small indicates that their influence on overall model complexity is negligible. Instead, these parameters are utilized to improve convergence toward a global minimum during the calibration process.

TABLE 3
Perspective Transform Matrix

| P₁₁ | P₁₂ | P₁₃ |
|---|---|---|
| 0.205 | −0.013 | 362.60 |

| P₂₁ | P₂₂ | P₂₃ |
|---|---|---|
| −0.016 | 0.350 | 409.13 |

| \|P₃₁\| | \|P₃₂\| | P₃₃ |
|---|---|---|
| <10⁻⁴ | <10⁻⁴ | 1 |

TABLE 4
Polynomial Coefficients

| a₀ | a₁ | a₂ | \|a₃\| | \|a₄\| |
|---|---|---|---|---|
| −422.37 | 0 | −0.0062 | <10⁻⁶ | <10⁻⁹ |

TABLE 5
Extrinsic Parameters

| θₓ | θ_{y} | θ_{z} | tₓ | t_{y} | t_{z} |
|---|---|---|---|---|---|
| 2.150 | −2.275 | −0.113 | −9.246 | −2.522 | 214.73 |

By using three-dimensional positions of the checkerboard derived from camera calibration as reference points, an average reprojection error of 0.49 pixels was measured during the projector calibration process. In addition, reprojection errors obtained in the present invention were compared with results from prior studies using similar systems. The method of the present invention achieved significantly lower reprojection errors than those of the prior studies in both camera calibration and projector calibration. In particular, more accurate calibration results were obtained even without using auxiliary equipment such as a transparent acrylic checkerboard.

### Three-Dimensional Reconstruction Results

### (1) Quantitative Analysis

For quantitative analysis, a planar surface was reconstructed, and vertical error and a standard deviation of the error were evaluated. In addition, an acrylic cylinder was reconstructed to further demonstrate omnidirectional reconstruction capability of the system. Results of the quantitative analysis are summarized in Table 6 (3D Reconstruction Error Analysis on Planar and Cylindrical Surfaces). A total of 64,747 points were sampled on a reference plane, and 181,559 points were reconstructed within a region of interest of the reference cylinder.

TABLE 6

| Object | Mean Error (mm) | Standard Deviation (mm) |
|---|---|---|
| Plane | 0.87 | 0.58 |
| Cylinder | 1.79 | 1.46 |

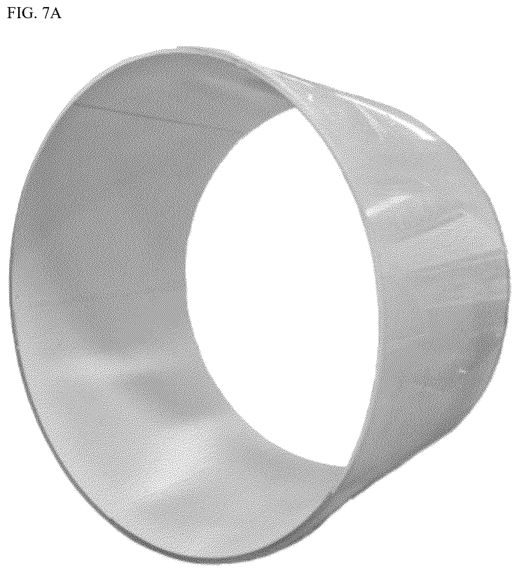

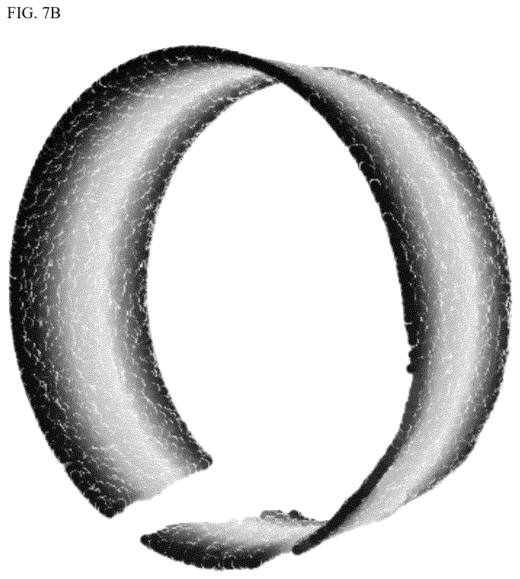

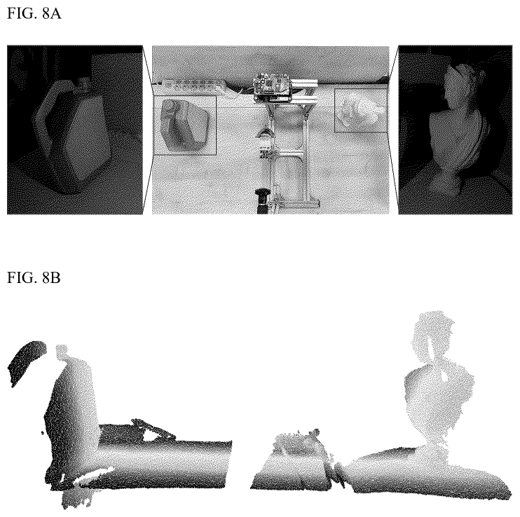

A spatial distribution of vertical error on the planar surface was visualized as a heat map in FIG. 6. In addition, three-dimensional reconstruction results of the cylinder were represented as a dense point cloud in FIGS. 7A and 7B, and a measured average radius of the cylinder was 246.34 mm. FIG. 8A illustrates an actual scene to be reconstructed. FIG. 8B illustrates a three-dimensional reconstruction result of the scene.

### (2) Qualitative Analysis

For qualitative analysis, a three-dimensional scene including a statue, a plastic bottle, and a planar floor was reconstructed. Visual results are shown in FIG. 8. These results demonstrate that individual components in the scene are clearly distinguishable, thereby verifying omnidirectional three-dimensional reconstruction capability of the proposed system.

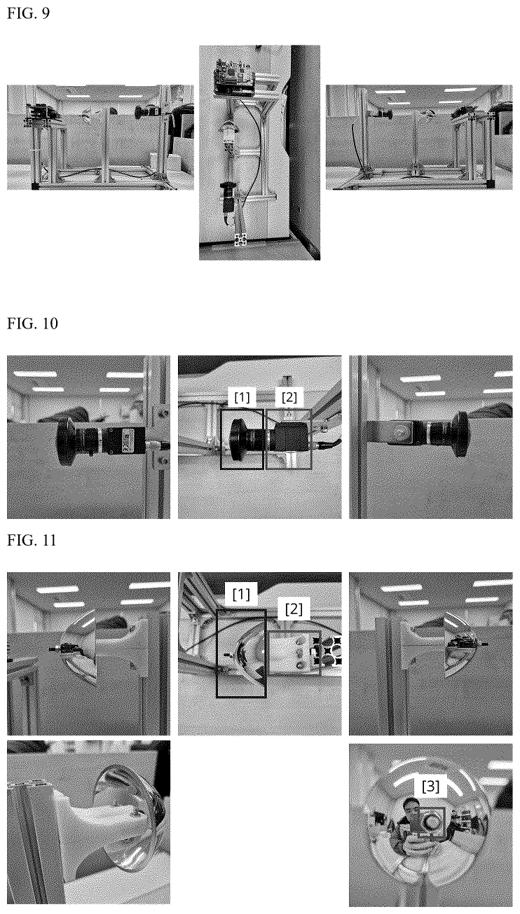

FIG. 9 is a diagram illustrating an overall configuration of a fisheye camera-catadioptric projector structured light system according to the present invention. Referring to FIG. 9, it can be seen that main components of the system are fixed by an aluminum frame. A left image shows a side view of the system, in which positions of the fisheye camera and the catadioptric projector are clearly illustrated. A center image shows upper and middle portions of the system, revealing a modular configuration in which electronic devices and connection wiring are mounted. A right image shows an opposite side view, indicating that the fisheye camera and the projector are disposed at opposite positions. Through FIG. 9, it can be confirmed that a hardware structure implementing the present invention is manufactured based on a compact yet stable design.

FIG. 10 is a diagram illustrating a detailed configuration of a fisheye camera according to the present invention. Referring to FIG. 10, detailed views of the fisheye camera and associated components viewed from left, top, and right directions can be confirmed. A left image shows a side view of a camera lens and a camera module, in which a FUJINON FE185C057HA-1 fisheye lens and a Teledyne FLIR BFS-U3-23S5C-C camera module are used. Another image illustrates an upper configuration of the fisheye camera and a connection state between the lens and the module, showing that respective components are fixed to a frame. A further image shows a view from an opposite side of the fisheye camera, indicating that the lens and the module are firmly secured. Through FIG. 10, it can be confirmed that the fisheye camera system is designed based on precise lens-module coupling and stable fixation.

FIG. 11 is a diagram illustrating a detailed configuration of a convex mirror used in the present invention. Referring to FIG. 11, a structure of the convex mirror observed from left, top, right, front, and rear-right directions can be identified. According to the drawings, the convex mirror was purchased from 0-360.com and is shown as being fixed to a custom-fabricated mount. A left image shows a curved surface of the mirror and a connection state with the mount as viewed from a side, while a top image more clearly illustrates a coupling structure between the mirror and the mount. Through FIG. 11, it can be confirmed that the design and assembly of the convex mirror and the mount are robust and provide a structure with high reflective efficiency.

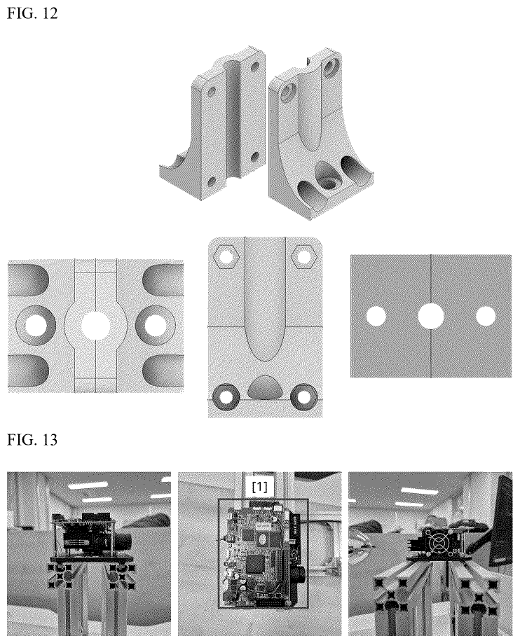

FIG. 12 is a diagram illustrating a detailed configuration of a custom-fabricated convex mirror mount used in the present invention. Referring to FIG. 12, structural features and design details of the mount can be identified through a plan view, a left side view, and a bottom view. In the plan view, an arrangement of a central hole and additional holes for fixing the convex mirror can be clearly observed. In the left side view, a curved design and a structure of a curved support portion for stably fixing the convex mirror are emphasized. The bottom view clearly shows a base structure of the mount and positions of fixing holes. Through FIG. 12, it can be confirmed that the mount is designed to firmly secure the convex mirror and to stably maintain the convex mirror even under external impacts.

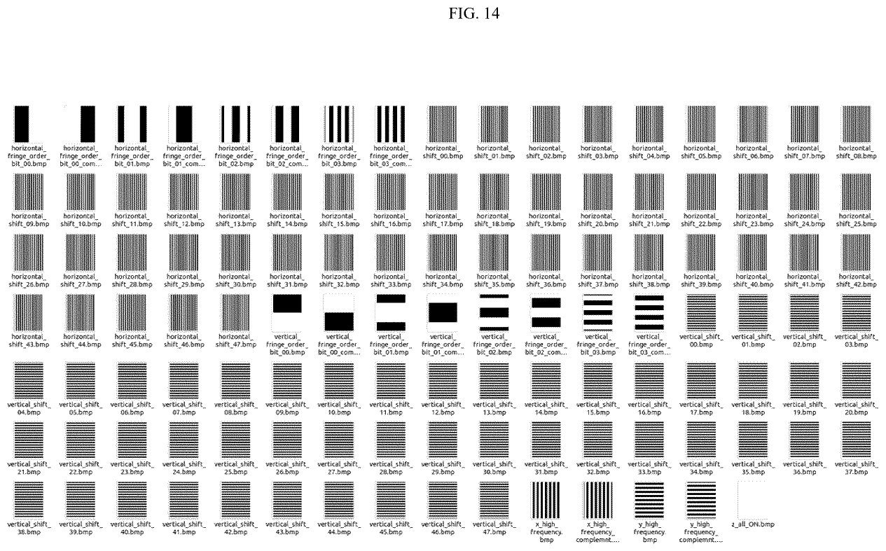

FIG. 13 is a diagram illustrating a detailed configuration of a projector used in an embodiment of the present invention. Referring to FIG. 13, structures and main components of the projector can be identified from left, top, and right views. The highlighted portion corresponds to an EKB Technologies DPM-E4500MKII-Green projector, which includes a green light source having a wavelength of 525 nm. In a top view, electronic circuitry and a cooling system of the projector can be clearly observed, while in left and right views, a configuration in which the projector is fixed to an aluminum profile and an arrangement of components can be identified. Through FIG. 13, it can be confirmed that the projector used in the present invention is designed with efficient thermal management and structural stability, and is optimized for high-precision structured light projection.

FIG. 14 is a diagram illustrating a pattern sequence used in an embodiment of the present invention. Referring to FIG. 14, the pattern sequence includes 55 pattern images in a horizontal direction and 55 pattern images in a vertical direction, and further includes four high-frequency patterns and one white pattern. The pattern images are classified into horizontal_shift and vertical_shift, and corresponding shift values and bit orders are specified. These patterns are structured light patterns used during light projection and analysis processes, and are designed to acquire accurate three-dimensional information. Through FIG. 14, it can be confirmed that by using patterns configured with various directions and frequencies, the system is capable of extracting more precise and complex three-dimensional data.

The present invention has been described above with reference to preferred embodiments; however, it will be understood by those skilled in the art that various modifications and changes may be made without departing from the spirit and scope of the present invention as set forth in the appended claims.

What is claimed is:

1. A structured light system, comprising:
a light projection unit including a light source configured to project a predetermined light pattern onto an object through reflection or refraction;
an imaging unit configured to capture, using a fisheye camera, the light pattern projected onto the object; and
a processing unit configured to compute and derive three-dimensional spatial information of the object based on information related to the light pattern projected by the light projection unit and information related to an image captured by the imaging unit.

2. The structured light system of claim 1,
wherein the light source includes a projector.

3. The structured light system of claim 1,
wherein the processing unit includes a memory storing at least one instruction and a processor,
and wherein the at least one instruction, when executed by the processor, causes the processor to:
(a) establish a geometric model of light rays of the structured light system;
(b) perform calibration based on the geometric model and a checkerboard having a predetermined pattern; and
(c) derive three-dimensional spatial information of the object based on the calibrated result.

4. The structured light system of claim 3,
wherein step (a) comprises:
(a-1) modeling ideal image-plane coordinates (u, v) and three-dimensional spatial coordinates (x, y, z) of an object using Equation (1) and Equation (2);
(a-2) modeling a reflected light ray lᵣ parallel to a z-axis of a mirror using the ideal image-plane coordinates (u, v) a depth s of the reflected light ray expressed by Equation (6), and Equation (3);
(a-3) modeling a light ray lᵣ′ on a real distorted image plane using the reflected light ray l_{y}, a rotation matrix R expressed by Equation (4-1), a translation vector T expressed by Equation (4-2), and Equation (4);
(a-4) modeling real distorted image-plane coordinates (u′, v′) using the light ray lᵣ′ on the real distorted image plane, Equation (5), and Equation (6);
(a-5) modeling a transformation relationship between the ideal image-plane coordinates (u, v) and the real distorted image-plane coordinates (u′, v′) based on Equation (7) and Equation (8); and
(a-6) modeling a transformation relationship according to Equation (9) by extending an affine transform to a perspective transform through introduction of additional parameters p₃₁ and p₃₂ that reflect distortion caused by a perspective effect in Equation (7) and Equation (8),
wherein
$$ρ = {( {u}^{2} + {v}^{2} )}^{\frac{1}{2}} .$$
$$X = [ \text{} \begin{matrix}x \\ y \\ Z\end{matrix} \text{} ] = λ [ \text{} \begin{matrix}u \\ v \\ f ( u , v )\end{matrix} ] \qquad Equation ( 1 )$$
$$f ( u , v ) = {a}_{0} + {a}_{2} {ρ}^{2} + {a}_{3} {ρ}^{3} + {a}_{4} {ρ}^{4} + {a}_{5} {ρ}^{5} \qquad Equation ( 2 )$$
$${l}_{r} = [ \text{} \begin{matrix}u \\ v \\ s\end{matrix} \text{} ] \qquad Equation ( 3 )$$
$${l}_{r}^{′} = [ \text{} \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} \text{} ] [ \text{} \begin{matrix}u \\ v \\ s\end{matrix} \text{} ] + [ \text{} \begin{matrix}{t}_{1} \\ {t}_{2} \\ {t}_{3}\end{matrix} \text{} ] \qquad Equation ( 4 )$$
$$[ \text{} \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} \text{} ] \qquad Equation ( 4 - 1 )$$
$$[ \text{} \begin{matrix}{t}_{1} \\ {t}_{2} \\ {t}_{3}\end{matrix} \text{} ] \qquad Equation ( 4 - 2 )$$
$${l}_{r}^{′} = [ \text{} \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} \text{} ] [ \text{} \begin{matrix}u \\ v \\ s\end{matrix} \text{} ] + [ \text{} \begin{matrix}{t}_{1} \\ {t}_{2} \\ {t}_{3}\end{matrix} \text{} ] = [ \text{} \begin{matrix}{u}^{′} \\ {v}^{′} \\ 0\end{matrix} \text{} ] \qquad Equation ( 5 )$$
$$s = - \frac{{r}_{31} u + {r}_{32} v + {t}_{3}}{{r}_{33}} \qquad Equation ( 6 )$$
$$[ \text{} \begin{matrix}{u}^{′} \\ {v}^{′}\end{matrix} \text{} ] = [ \text{} \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} \text{} ] [ \text{} \begin{matrix}u \\ v \\ 1\end{matrix} \text{} ] \qquad Equation ( 7 )$$
$$[ \text{} \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} \text{} ] [ \text{} \begin{matrix}u \\ v \\ 1\end{matrix} \text{} ] = [ \text{} \begin{matrix}{a}_{11} & {a}_{12} \\ {a}_{21} & {a}_{22}\end{matrix} \text{} ] [ \text{} \begin{matrix}u \\ v\end{matrix} \text{} ] + [ \text{} \begin{matrix}{c}_{1} \\ {c}_{2}\end{matrix} \text{} ] \qquad Equation ( 8 )$$
$${λ}_{projection} [ \text{} \begin{matrix}{u}^{′} \\ {v}^{′} \\ 1\end{matrix} \text{} ] = [ \text{} \begin{matrix}{p}_{11} & {p}_{12} & {p}_{13} \\ {p}_{21} & {p}_{22} & {p}_{23} \\ {p}_{31} & {p}_{32} & 1\end{matrix} \text{} ] [ \text{} \begin{matrix}u \\ v \\ 1\end{matrix} \text{} ] \qquad Equation ( 9 )$$

5. The structured light system of claim 4,
wherein step (b) comprises:
(b-1) extending an existing omnidirectional camera model using the ideal image-plane coordinates (u, v), the real distorted image-plane coordinates (u′, v′), the parameters p₃₁ and p₃₂, and Equation (10);
(b-2) deriving a relationship between ideal image-plane coordinates of a specific point on the object and a three-dimensional position of the point using Equation (11), Equation (12), a rotation matrix R and a translation vector T;
(b-3) deriving relational equations expressed by Equation (13a), Equation (13b), and Equation (13c) from Equation (12);
(b-4) deriving a relationship expressed by Equation (14) between a calibration parameter vector H expressed by Equation (15) and a calibration data matrix M expressed by Equation (16), and obtaining a solution using a least-squares method;
(b-5) deriving coefficients aₙ of Equation (2) using transformation coefficients A, B, C, and D expressed by Equation (18) and Equation (19), which are related to elements of the rotation matrix R, three-dimensional coordinates of checkerboard corners, and elements of the translation vector T, together with Equation (17);
(b-6) deriving a residual function r r representing a difference between an actual coordinate and a predicted coordinate using Equation (20), wherein m is one of the real distorted image-plane coordinates (u′, v′), \hat{m} is a coordinate predicted by the model, and k indicates an axis of the coordinate;
(b-7) defining an error function E based on the residual function r, the parameters p₃₁ and p₃₂, and Equation (21), and searching for parameters expressed as a set in Equation (22) to minimize the error function; and
(b-8) transforming a coordinate system of the light source and a coordinate system of the fisheye camera using Equation (23), and performing nonlinear optimization on parameters to be optimized expressed by Equation (24),
wherein: λ is a scale factor; x and y are three-dimensional coordinates of checkerboard corners; superscript i denotes an index of each checkerboard; subscript j denotes an index of each corner of the checkerboard; L is a number of corners of the checkerboard; K is a number of checkerboards used for calibration; P is a projection matrix defined in Equation (9); in Equation (20), k is 1 when m is u′, and 2 when m is v′; an arrow in Equation (23) indicates a direction of coordinate transformation; proj denotes the light source; cam denotes a fisheye camera coordinate system; and board denotes the checkerboard.
$$[ \text{} \begin{matrix}{u}^{′} \\ {v}^{′} \\ 1\end{matrix} \text{} ] = [ \text{} \begin{matrix}1 & 0 & {p}_{13} \\ 0 & 1 & {p}_{23} \\ 0 & 0 & 1\end{matrix} \text{} ] [ \text{} \begin{matrix}u \\ v \\ 1\end{matrix} \text{} ] \qquad Equation ( 10 )$$
$$λ [ \text{} \begin{matrix}{u}_{j}^{i} \\ {v}_{j}^{i} \\ f ( {u}_{j}^{i} , {v}_{j}^{i} )\end{matrix} \text{} ] = [ \text{} \begin{matrix}{r}_{1}^{i} & {r}_{2}^{i} & {r}_{3}^{i} & {t}^{i}\end{matrix} \text{} ] [ \text{} \begin{matrix}{x}_{j}^{i} \\ {y}_{j}^{i} \\ 0 \\ 1\end{matrix} \text{} ] = [ \text{} \begin{matrix}{r}_{1}^{i} & {r}_{2}^{i} & {t}^{i}\end{matrix} \text{} ] [ \text{} \begin{matrix}{x}_{j}^{i} \\ {y}_{j}^{i} \\ 1\end{matrix} \text{} ] \qquad Equation ( 11 )$$
$$[ \text{} \begin{matrix}{u}_{j}^{i} \\ {v}_{j}^{i} \\ f ( {u}_{j}^{i} , {v}_{j}^{i} )\end{matrix} \text{} ] \times [ \text{} \begin{matrix}{r}_{1}^{i} & {r}_{2}^{i} & {t}^{i}\end{matrix} \text{} ] [ \text{} \begin{matrix}{x}_{j}^{i} \\ {y}_{j}^{i} \\ 1\end{matrix} \text{} ] = 0 \qquad Equation ( 12 )$$
$${v}_{j}^{i} \cdot ( {r}_{31}^{i} {x}_{j}^{i} + {r}_{32}^{i} {y}_{j}^{i} + {t}_{3}^{i} ) - f ( {u}_{j}^{i} , {v}_{j}^{i} ) \cdot ( {r}_{21}^{i} {x}_{j}^{i} + {r}_{22}^{i} {y}_{j}^{i} + {t}_{2}^{i} ) = 0 \qquad Equation ( 13 a )$$
$$f ( {u}_{j}^{i} , {v}_{j}^{i} ) \cdot ( {r}_{11}^{i} {x}_{j}^{i} + {r}_{12}^{i} {y}_{j}^{i} + {t}_{1}^{i} ) - {u}_{j}^{i} \cdot ( {r}_{31}^{i} {x}_{j}^{i} + {r}_{32}^{i} {y}_{j}^{i} + {t}_{3}^{i} ) = 0 \qquad Equation ( 13 b )$$
$${u}_{j}^{i} \cdot ( {r}_{21}^{i} {x}_{j}^{i} + {r}_{22}^{i} {y}_{j}^{i} + {t}_{2}^{i} ) - {v}_{j}^{i} \cdot ( {r}_{11}^{i} {x}_{j}^{i} + {r}_{12}^{i} {y}_{j}^{i} + {t}_{1}^{i} ) = 0 \qquad Equation ( 13 c )$$
$$M \cdot H = 0 \qquad Equation ( 14 )$$
$$H = {[ {r}_{11}^{i} , {r}_{12}^{i} , {r}_{21}^{i} , {r}_{22}^{i} , {t}_{1}^{i} , {t}_{2}^{i} ]}^{T} \qquad Equation ( 15 )$$
$$M = [ \text{} \begin{matrix}- {v}_{1}^{i} {x}_{1}^{i} & - {v}_{1}^{i} {y}_{1}^{i} & {u}_{1}^{i} {x}_{1}^{i} & {u}_{1}^{i} {y}_{1}^{i} & - {v}_{1}^{i} & {u}_{1}^{i} \\ ⋮ & ⋮ & ⋮ & ⋮ & ⋮ & ⋮ \\ - {v}_{L}^{i} {x}_{L}^{i} & - {v}_{L}^{i} {y}_{L}^{i} & {u}_{L}^{i} {x}_{L}^{i} & {u}_{L}^{i} {y}_{L}^{i} & - {v}_{L}^{i} & {u}_{L}^{i}\end{matrix} \text{} ] \qquad Equation ( 16 )$$
$$[ \text{} \begin{matrix}{A}_{1}^{1} & {{A}_{1}^{1} ( {ρ}_{1}^{1} )}^{2} & {A}_{1}^{1} {( {ρ}_{1}^{1} )}^{3} & {A}_{1}^{1} {( {ρ}_{1}^{1} )}^{4} & - {v}_{1}^{1} & 0 & ⋯ & 0 \\ {C}_{1}^{1} & {{C}_{1}^{1} ( {ρ}_{1}^{1} )}^{2} & {{C}_{1}^{1} ( {ρ}_{1}^{1} )}^{3} & {{C}_{1}^{1} ( {ρ}_{1}^{1} )}^{4} & - {u}_{1}^{1} & 0 & ⋯ & 0 \\ {A}_{2}^{1} & {A}_{2}^{1} {( {ρ}_{2}^{1} )}^{2} & {A}_{2}^{1} {( {ρ}_{2}^{1} )}^{3} & {A}_{2}^{1} {( {ρ}_{2}^{1} )}^{4} & - {v}_{2}^{1} & 0 & ⋯ & 0 \\ {C}_{2}^{1} & {C}_{2}^{1} {( {ρ}_{2}^{1} )}^{2} & {C}_{2}^{1} {( {ρ}_{2}^{1} )}^{3} & {C}_{2}^{1} {( {ρ}_{2}^{1} )}^{4} & - {u}_{2}^{1} & 0 & ⋯ & 0 \\ ⋮ & ⋮ & ⋮ & ⋮ & ⋮ & ⋮ & ⋱ & ⋮ \\ {A}_{L}^{K} & {{A}_{L}^{K} ( {ρ}_{L}^{K} )}^{2} & {A}_{L}^{K} {( {ρ}_{L}^{K} )}^{3} & {A}_{L}^{K} {( {ρ}_{L}^{K} )}^{4} & 0 & 0 & ⋯ & - {v}_{L}^{K} \\ {C}_{L}^{K} & {{C}_{L}^{K} ( {ρ}_{L}^{K} )}^{2} & {{C}_{L}^{K} ( {ρ}_{L}^{K} )}^{3} & {{C}_{L}^{K} ( {ρ}_{L}^{K} )}^{4} & 0 & 0 & ⋯ & - {u}_{L}^{K}\end{matrix} \text{} ] [ \text{} \begin{matrix}{a}_{0} \\ {a}_{2} \\ {a}_{3} \\ {a}_{4} \\ {t}_{3}^{1} \\ {t}_{3}^{2} \\ ⋮ \\ {t}_{3}^{k}\end{matrix} \text{} ] = [ \text{} \begin{matrix}{B}_{1}^{1} \\ {D}_{1}^{1} \\ {B}_{2}^{1} \\ {D}_{2}^{1} \\ ⋮ \\ {B}_{L}^{K} \\ {D}_{L}^{K}\end{matrix} \text{} ] \qquad Equation ( 17 )$$
$${A}_{j}^{i} = {r}_{21}^{i} {x}_{j}^{i} + {r}_{22}^{i} {y}_{j}^{i} + {t}_{2}^{i} , {B}_{j}^{i} = {v}_{j}^{i} \cdot ( {r}_{31}^{i} {x}_{j}^{i} + {r}_{32}^{i} {y}_{j}^{i} ) \qquad Equation ( 18 )$$
$${C}_{j}^{i} = {r}_{11}^{i} {x}_{j}^{i} + {r}_{12}^{i} {y}_{j}^{i} + {t}_{1}^{i} , {D}_{j}^{i} = {u}_{j}^{i} \cdot ( {r}_{31}^{i} {x}_{j}^{i} + {r}_{32}^{i} {y}_{j}^{i} ) \qquad Equation ( 19 )$$
$$r ( m , \hat{m} , k ) = m - \hat{m} \qquad Equation ( 20 )$$
$${\sum }_{i = 1}^{K} {\sum }_{j = 1}^{L} {\sum }_{k = 1}^{2} {r ( m , \hat{m} ( \hat{U} , {M}_{j}^{i} ) , k )}^{2} + {( {p}_{31} )}^{2} + {( {p}_{32} )}^{2} \qquad Equation ( 21 )$$
$$\hat{U} = [ {r}^{i} , {t}^{i} , a , P ] \qquad Equation ( 22 )$$
$${T}_{proj \to cam} = \frac{1}{K} {\sum }_{i = 1}^{K} ( {{T}_{board \to cam}^{i} ( {T}_{board \to proj}^{i} )}^{- 1} ) \qquad Equation ( 23 )$$
$$\hat{U} = [ {r}_{proj \to cam} , {t}_{proj \to cam} , {a}_{p} , {P}_{p} ] \qquad Equation ( 24 )$$

6. The structured light system of claim 5,
wherein step (c) comprises:
(c-1) deriving a light ray l_{c} originating from a virtual paraboloid center using Equation (25) based on undistorted camera pixel coordinates (u_{c}, v_{c});
(c-2) deriving, in a camera coordinate system, a light ray lₚ from pixel coordinates (uₚ, vₚ) of the light source using Equation (26); and
(c-3) deriving Equation (27) or Equation (28) from the camera light ray l_{c} and the light source light ray lₚ, obtaining a scale factor λ_{c} therefrom, and deriving a reconstructed three-dimensional point X in space by substituting the scale factor λ_{c} into Equation (25), wherein Oₚ is an origin of the light source.
$${l}_{c} = {λ}_{c} [ \text{} \begin{matrix}{u}_{c} \\ {v}_{c} \\ f ( {u}_{c} , {v}_{c} )\end{matrix} ] = λ [ \text{} \begin{matrix}{c}_{1} \\ {c}_{2} \\ {c}_{3}\end{matrix} \text{} ] \qquad Equation ( 25 )$$
$${l}_{p} = {λ}_{p} {R}_{proj \to cam} [ \text{} \begin{matrix}{u}_{p} \\ {v}_{p} \\ f ( {u}_{p} , {v}_{p} )\end{matrix} ] + {O}_{p} = {λ}_{p} [ \text{} \begin{matrix}{p}_{1} \\ {p}_{2} \\ {p}_{3}\end{matrix} \text{} ] + {O}_{p} \qquad Equation ( 26 )$$
$$X = {λ}_{c} [ \text{} \begin{matrix}{c}_{1} \\ {c}_{2} \\ {c}_{3}\end{matrix} \text{} ] = {λ}_{p} [ \text{} \begin{matrix}{p}_{1} \\ {p}_{2} \\ {p}_{3}\end{matrix} \text{} ] + [ \text{} \begin{matrix}{O}_{{p}_{x}} \\ {O}_{{p}_{y}} \\ {O}_{{p}_{z}}\end{matrix} \text{} ] \qquad Equation ( 27 )$$
$$[ \text{} \begin{matrix}{c}_{1} & - {p}_{1} \\ {c}_{2} & - {p}_{2} \\ {c}_{3} & - {p}_{3}\end{matrix} \text{} ] [ \text{} \begin{matrix}{λ}_{c} \\ {λ}_{p}\end{matrix} \text{} ] = [ \text{} \begin{matrix}{O}_{{p}_{x}} \\ {O}_{{p}_{y}} \\ {O}_{{p}_{z}}\end{matrix} \text{} ] \qquad Equation ( 28 )$$

7. A method for acquiring spatial information, comprising:
projecting, using a light source, a predetermined light pattern onto an object through reflection or refraction;
capturing, using a fisheye camera, the light pattern projected onto the object; and
computing and deriving three-dimensional spatial information of the object based on information related to the light pattern and information related to an image captured by the fisheye camera,
wherein the computing and deriving of the three-dimensional spatial information is performed by at least one processor.

8. The method of claim 7,
wherein the light source includes a projector.

9. The method of claim 7,
wherein the computing and deriving of the three-dimensional spatial information comprises:
(a) establishing a geometric model of light rays of the light source;
(b) performing calibration based on the geometric model and a checkerboard having a predetermined pattern; and
(c) deriving three-dimensional spatial information of the object based on the calibrated result.

10. The method of claim 9,
wherein step (a) comprises:
(a-1) modeling ideal image-plane coordinates (u, v) and three-dimensional spatial coordinates (x, y, z) of an object using Equation (1) and Equation (2);
(a-2) modeling a reflected light ray lᵣ parallel to a z-axis of a mirror using the ideal image-plane coordinates (u, v) a depth s of the reflected light ray expressed by Equation (6), and Equation (3);
(a-3) modeling a light ray lᵣ′ on a real distorted image plane using the reflected light ray lᵣ, a rotation matrix R expressed by Equation (4-1), a translation vector T expressed by Equation (4-2), and Equation (4);
(a-4) modeling real distorted image-plane coordinates (u′, v′) using the light ray lᵣ′ on the real distorted image plane, Equation (5), and Equation (6);
(a-5) modeling a transformation relationship between the ideal image-plane coordinates (u, v) and the real distorted image-plane coordinates (u′, v′) based on Equation (7) and Equation (8); and
(a-6) modeling a transformation relationship according to Equation (9) by extending an affine transform to a perspective transform through introduction of additional parameters p₃₁ and p₃₂ that reflect distortion caused by a perspective effect in Equation (7) and Equation (8),
wherein
$$ρ = {( {u}^{2} + {v}^{2} )}^{\frac{1}{2}} .$$
$$X = [ \text{} \begin{matrix}x \\ y \\ z\end{matrix} \text{} ] = λ [ \text{} \begin{matrix}u \\ v \\ f ( u , v )\end{matrix} ] \qquad Equation ( 1 )$$
$$f ( u , v ) = {a}_{0} + {a}_{2} {ρ}^{2} + {a}_{3} {ρ}^{3} + {a}_{4} {ρ}^{4} + {a}_{5} {ρ}^{5} \qquad Equation ( 2 )$$
$${l}_{r} = [ \text{} \begin{matrix}u \\ v \\ s\end{matrix} \text{} ] \qquad Equation ( 3 )$$
$${l}_{r}^{′} = [ \text{} \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} \text{} ] [ \text{} \begin{matrix}u \\ v \\ s\end{matrix} \text{} ] + [ \text{} \begin{matrix}{t}_{1} \\ {t}_{2} \\ {t}_{3}\end{matrix} \text{} ] \qquad Equation ( 4 )$$
$$[ \text{} \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} \text{} ] \qquad Equation ( 4 - 1 )$$
$$[ \text{} \begin{matrix}{t}_{1} \\ {t}_{2} \\ {t}_{3}\end{matrix} \text{} ] \qquad Equation ( 4 - 2 )$$
$${l}_{r}^{′} = [ \text{} \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} \text{} ] [ \text{} \begin{matrix}u \\ v \\ s\end{matrix} \text{} ] + [ \text{} \begin{matrix}{t}_{1} \\ {t}_{2} \\ {t}_{3}\end{matrix} \text{} ] = [ \text{} \begin{matrix}{u}^{′} \\ {v}^{′} \\ 0\end{matrix} \text{} ] \qquad Equation ( 5 )$$
$$s = - \frac{{r}_{31} u + {r}_{32} v + {t}_{3}}{{r}_{33}} \qquad Equation ( 6 )$$
$$[ \text{} \begin{matrix}{u}^{′} \\ {v}^{′}\end{matrix} \text{} ] = [ \text{} \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} \text{} ] [ \text{} \begin{matrix}u \\ v \\ 1\end{matrix} \text{} ] \qquad Equation ( 7 )$$
$$[ \text{} \begin{matrix}{r}_{11} - \frac{{r}_{13} {r}_{31}}{{r}_{33}} & {r}_{12} - \frac{{r}_{13} {r}_{32}}{{r}_{33}} & {t}_{1} - \frac{{r}_{13} {t}_{3}}{{r}_{33}} \\ {r}_{21} - \frac{{r}_{23} {r}_{31}}{{r}_{33}} & {r}_{22} - \frac{{r}_{23} {r}_{32}}{{r}_{33}} & {t}_{2} - \frac{{r}_{23} {t}_{3}}{{r}_{33}}\end{matrix} \text{} ] [ \text{} \begin{matrix}u \\ v \\ 1\end{matrix} \text{} ] = [ \text{} \begin{matrix}{a}_{11} & {a}_{12} \\ {a}_{21} & {a}_{22}\end{matrix} \text{} ] [ \text{} \begin{matrix}u \\ v\end{matrix} \text{} ] + [ \text{} \begin{matrix}{c}_{1} \\ {c}_{2}\end{matrix} \text{} ] \qquad Equation ( 8 )$$
$${λ}_{projection} [ \text{} \begin{matrix}{u}^{′} \\ {v}^{′} \\ 1\end{matrix} \text{} ] = [ \text{} \begin{matrix}{p}_{11} & {p}_{12} & {p}_{13} \\ {p}_{21} & {p}_{22} & {p}_{23} \\ {p}_{31} & {p}_{32} & 1\end{matrix} \text{} ] [ \text{} \begin{matrix}u \\ v \\ 1\end{matrix} \text{} ] \qquad Equation ( 9 )$$

11. The method of claim 10,
wherein step (b) comprises:
(b-1) extending an existing omnidirectional camera model using the ideal image-plane coordinates (u, v), the real distorted image-plane coordinates (u′, v′), the parameters p₃₁ and p₃₂, and Equation (10);
(b-2) deriving a relationship between ideal image-plane coordinates of a specific point on the object and a three-dimensional position of the point using Equation (11), Equation (12), a rotation matrix R and a translation vector T;
(b-3) deriving relational equations expressed by Equation (13a), Equation (13b), and Equation (13c) from Equation (12);
(b-4) deriving a relationship expressed by Equation (14) between a calibration parameter vector H expressed by Equation (15) and a calibration data matrix M expressed by Equation (16), and obtaining a solution using a least-squares method;
(b-5) deriving coefficients aₙ of Equation (2) using transformation coefficients A, B, C, and D expressed by Equation (18) and Equation (19), which are related to elements of the rotation matrix R, three-dimensional coordinates of checkerboard corners, and elements of the translation vector T, together with Equation (17);
(b-6) deriving a residual function r r representing a difference between an actual coordinate and a predicted coordinate using Equation (20), wherein m is one of the real distorted image-plane coordinates (u′, v′), \hat{m} is a coordinate predicted by the model, and k indicates an axis of the coordinate;
(b-7) defining an error function E based on the residual function r, the parameters p₃₁ and p₃₂, and Equation (21), and searching for parameters expressed as a set in Equation (22) to minimize the error function; and
(b-8) transforming a coordinate system of the light source and a coordinate system of the fisheye camera using Equation (23), and performing nonlinear optimization on parameters to be optimized expressed by Equation (24),
wherein: λ is a scale factor; x and y are three-dimensional coordinates of checkerboard corners; superscript i denotes an index of each checkerboard; subscript j denotes an index of each corner of the checkerboard; L is a number of corners of the checkerboard; K is a number of checkerboards used for calibration; P is a projection matrix defined in Equation (9); in Equation (20), k is 1 when m is u′, and 2 when m is v′; an arrow in Equation (23) indicates a direction of coordinate transformation; proj denotes the light source; cam denotes a fisheye camera coordinate system; and board denotes the checkerboard.
$$[ \text{} \begin{matrix}{u}^{′} \\ {v}^{′} \\ 1\end{matrix} \text{} ] = [ \text{} \begin{matrix}1 & 0 & {p}_{13} \\ 0 & 1 & {p}_{23} \\ 0 & 0 & 1\end{matrix} \text{} ] [ \text{} \begin{matrix}u \\ v \\ 1\end{matrix} \text{} ] \qquad Equation ( 10 )$$
$$λ [ \text{} \begin{matrix}{u}_{j}^{i} \\ {v}_{j}^{i} \\ f ( {u}_{j}^{i} , {v}_{j}^{i} )\end{matrix} \text{} ] = [ \text{} \begin{matrix}{r}_{1}^{i} & {r}_{2}^{i} & {r}_{3}^{i} & {t}^{i}\end{matrix} \text{} ] [ \text{} \begin{matrix}{x}_{j}^{i} \\ {y}_{j}^{i} \\ 0 \\ 1\end{matrix} \text{} ] = [ \text{} \begin{matrix}{r}_{1}^{i} & {r}_{2}^{i} & {t}^{i}\end{matrix} \text{} ] [ \text{} \begin{matrix}{x}_{j}^{i} \\ {y}_{j}^{i} \\ 1\end{matrix} \text{} ] \qquad Equation ( 11 )$$
$$[ \text{} \begin{matrix}{u}_{j}^{i} \\ {v}_{j}^{i} \\ f ( {u}_{j}^{i} , {v}_{j}^{i} )\end{matrix} \text{} ] \times [ \text{} \begin{matrix}{r}_{1}^{i} & {r}_{2}^{i} & {t}^{i}\end{matrix} \text{} ] [ \text{} \begin{matrix}{x}_{j}^{i} \\ {y}_{j}^{i} \\ 1\end{matrix} \text{} ] = 0 \qquad Equation ( 12 )$$
$${v}_{j}^{i} \cdot ( {r}_{31}^{i} {x}_{j}^{i} + {r}_{32}^{i} {y}_{j}^{i} + {t}_{3}^{i} ) - f ( {u}_{j}^{i} , {v}_{j}^{i} ) \cdot ( {r}_{21}^{i} {x}_{j}^{i} + {r}_{22}^{i} {y}_{j}^{i} + {t}_{2}^{i} ) = 0 \qquad Equation ( 13 a )$$
$$f ( {u}_{j}^{i} , {v}_{j}^{i} ) \cdot ( {r}_{11}^{i} {x}_{j}^{i} + {r}_{12}^{i} {y}_{j}^{i} + {t}_{1}^{i} ) - {u}_{j}^{i} \cdot ( {r}_{31}^{i} {x}_{j}^{i} + {r}_{32}^{i} {y}_{j}^{i} + {t}_{3}^{i} ) = 0 \qquad Equation ( 13 b )$$
$${u}_{j}^{i} \cdot ( {r}_{21}^{i} {x}_{j}^{i} + {r}_{22}^{i} {y}_{j}^{i} + {t}_{2}^{i} ) - {v}_{j}^{i} \cdot ( {r}_{11}^{i} {x}_{j}^{i} + {r}_{12}^{i} {y}_{j}^{i} + {t}_{1}^{i} ) = 0 \qquad Equation ( 13 c )$$
$$M \cdot H = 0 \qquad Equation ( 14 )$$
$$H = {[ {r}_{11}^{i} , {r}_{12}^{i} , {r}_{21}^{i} , {r}_{22}^{i} , {t}_{1}^{i} , {t}_{2}^{i} ]}^{T} \qquad Equation ( 15 )$$
$$M = [ \text{} \begin{matrix}- {v}_{1}^{i} {x}_{1}^{i} & - {v}_{1}^{i} {y}_{1}^{i} & {u}_{1}^{i} {x}_{1}^{i} & {u}_{1}^{i} {y}_{1}^{i} & - {v}_{1}^{i} & {u}_{1}^{i} \\ ⋮ & ⋮ & ⋮ & ⋮ & ⋮ & ⋮ \\ - {v}_{L}^{i} {x}_{L}^{i} & - {v}_{L}^{i} {y}_{L}^{i} & {u}_{L}^{i} {x}_{L}^{i} & {u}_{L}^{i} {y}_{L}^{i} & - {v}_{L}^{i} & {u}_{L}^{i}\end{matrix} \text{} ] \qquad Equation ( 16 )$$
$$[ \text{} \begin{matrix}{A}_{1}^{1} & {{A}_{1}^{1} ( {ρ}_{1}^{1} )}^{2} & {A}_{1}^{1} {( {ρ}_{1}^{1} )}^{3} & {A}_{1}^{1} {( {ρ}_{1}^{1} )}^{4} & - {v}_{1}^{1} & 0 & ⋯ & 0 \\ {C}_{1}^{1} & {{C}_{1}^{1} ( {ρ}_{1}^{1} )}^{2} & {{C}_{1}^{1} ( {ρ}_{1}^{1} )}^{3} & {{C}_{1}^{1} ( {ρ}_{1}^{1} )}^{4} & - {u}_{1}^{1} & 0 & ⋯ & 0 \\ {A}_{2}^{1} & {A}_{2}^{1} {( {ρ}_{2}^{1} )}^{2} & {A}_{2}^{1} {( {ρ}_{2}^{1} )}^{3} & {A}_{2}^{1} {( {ρ}_{2}^{1} )}^{4} & - {v}_{2}^{1} & 0 & ⋯ & 0 \\ {C}_{2}^{1} & {C}_{2}^{1} {( {ρ}_{2}^{1} )}^{2} & {C}_{2}^{1} {( {ρ}_{2}^{1} )}^{3} & {C}_{2}^{1} {( {ρ}_{2}^{1} )}^{4} & - {u}_{2}^{1} & 0 & ⋯ & 0 \\ ⋮ & ⋮ & ⋮ & ⋮ & ⋮ & ⋮ & ⋱ & ⋮ \\ {A}_{L}^{K} & {{A}_{L}^{K} ( {ρ}_{L}^{K} )}^{2} & {A}_{L}^{K} {( {ρ}_{L}^{K} )}^{3} & {A}_{L}^{K} {( {ρ}_{L}^{K} )}^{4} & 0 & 0 & ⋯ & - {v}_{L}^{K} \\ {C}_{L}^{K} & {{C}_{L}^{K} ( {ρ}_{L}^{K} )}^{2} & {{C}_{L}^{K} ( {ρ}_{L}^{K} )}^{3} & {{C}_{L}^{K} ( {ρ}_{L}^{K} )}^{4} & 0 & 0 & ⋯ & - {u}_{L}^{K}\end{matrix} \text{} ] [ \text{} \begin{matrix}{a}_{0} \\ {a}_{2} \\ {a}_{3} \\ {a}_{4} \\ {t}_{3}^{1} \\ {t}_{3}^{2} \\ ⋮ \\ {t}_{3}^{k}\end{matrix} \text{} ] = [ \text{} \begin{matrix}{B}_{1}^{1} \\ {D}_{1}^{1} \\ {B}_{2}^{1} \\ {D}_{2}^{1} \\ ⋮ \\ {B}_{L}^{K} \\ {D}_{L}^{K}\end{matrix} \text{} ] \qquad Equation ( 17 )$$
$${A}_{j}^{i} = {r}_{21}^{i} {x}_{j}^{i} + {r}_{22}^{i} {y}_{j}^{i} + {t}_{2}^{i} , {B}_{j}^{i} = {v}_{j}^{i} \cdot ( {r}_{31}^{i} {x}_{j}^{i} + {r}_{32}^{i} {y}_{j}^{i} ) \qquad Equation ( 18 )$$
$${C}_{j}^{i} = {r}_{11}^{i} {x}_{j}^{i} + {r}_{12}^{i} {y}_{j}^{i} + {t}_{1}^{i} , {D}_{j}^{i} = {u}_{j}^{i} \cdot ( {r}_{31}^{i} {x}_{j}^{i} + {r}_{32}^{i} {y}_{j}^{i} ) \qquad Equation ( 19 )$$
$$r ( m , \hat{m} , k ) = m - \hat{m} \qquad Equation ( 20 )$$
$${\sum }_{i = 1}^{K} {\sum }_{j = 1}^{L} {\sum }_{k = 1}^{2} {r ( m , \hat{m} ( \hat{U} , {M}_{j}^{i} ) , k )}^{2} + {( {p}_{31} )}^{2} + {( {p}_{32} )}^{2} \qquad Equation ( 21 )$$
$$\hat{U} = [ {r}^{i} , {t}^{i} , a , P ] \qquad Equation ( 22 )$$
$${T}_{proj \to cam} = \frac{1}{K} {\sum }_{i = 1}^{K} ( {{T}_{board \to cam}^{i} ( {T}_{board \to proj}^{i} )}^{- 1} ) \qquad Equation ( 23 )$$
$$\hat{U} = [ {r}_{proj \to cam} , {t}_{proj \to cam} , {a}_{p} , {P}_{p} ] \qquad Equation ( 24 )$$

12. The method of claim 11,
wherein step (c) comprises:
(c-1) deriving a light ray l_{c} originating from a virtual paraboloid center using Equation (25) based on undistorted camera pixel coordinates (u_{c}, v_{c});
(c-2) deriving, in a camera coordinate system, a light ray lₚ from pixel coordinates (uₚ, vₚ) of the light source using Equation (26); and
(c-3) deriving Equation (27) or Equation (28) from the camera light ray l_{c} and the light source light ray lₚ, obtaining a scale factor A, therefrom, and deriving a reconstructed three-dimensional point X in space by substituting the scale factor A, into Equation (25), wherein Oₚ is an origin of the light source.
$${l}_{c} = {λ}_{c} [ \text{} \begin{matrix}{u}_{c} \\ {v}_{c} \\ f ( {u}_{c} , {v}_{c} )\end{matrix} ] = λ [ \text{} \begin{matrix}{c}_{1} \\ {c}_{2} \\ {c}_{3}\end{matrix} \text{} ] \qquad Equation ( 25 )$$
$${l}_{p} = {λ}_{p} {R}_{proj \to cam} [ \text{} \begin{matrix}{u}_{p} \\ {v}_{p} \\ f ( {u}_{p} , {v}_{p} )\end{matrix} ] + {O}_{p} = {λ}_{p} [ \text{} \begin{matrix}{p}_{1} \\ {p}_{2} \\ {p}_{3}\end{matrix} \text{} ] + {O}_{p} \qquad Equation ( 26 )$$
$$X = {λ}_{c} [ \text{} \begin{matrix}{c}_{1} \\ {c}_{2} \\ {c}_{3}\end{matrix} \text{} ] = {λ}_{p} [ \text{} \begin{matrix}{p}_{1} \\ {p}_{2} \\ {p}_{3}\end{matrix} \text{} ] + [ \text{} \begin{matrix}{O}_{{p}_{x}} \\ {O}_{{p}_{y}} \\ {O}_{{p}_{z}}\end{matrix} \text{} ] \qquad Equation ( 27 )$$
$$[ \text{} \begin{matrix}{c}_{1} & - {p}_{1} \\ {c}_{2} & - {p}_{2} \\ {c}_{3} & - {p}_{3}\end{matrix} \text{} ] [ \text{} \begin{matrix}{λ}_{c} \\ {λ}_{p}\end{matrix} \text{} ] = [ \text{} \begin{matrix}{O}_{{p}_{x}} \\ {O}_{{p}_{y}} \\ {O}_{{p}_{z}}\end{matrix} \text{} ] \qquad Equation ( 28 )$$

13. A spatial information acquisition system comprising the structured light system of claim 1.
